(19) United States
(12) Patent Application Publication
(10) Pub. No.: US 2025/0219762 A1
(43) Pub. Date: Jul. 3, 2025

(54) APPARATUSES, SYSTEMS, AND METHODS FOR USER-EQUIPMENT COOPERATION USING RETRANSMISSIONS WITH CROSS-BLOCK CHECK BLOCKS

(71) Applicant: Huawei Technologies Co., Ltd., Shenzhen (CN)

(72) Inventors: Van Hung Vu, Gatineau (CA); Yu Cao, Kanata (CA)

(21) Appl. No.: 19/060,332

(22) Filed: Feb. 21, 2025

Related U.S. Application Data
(63) Continuation of application No. PCT/CN2022/114366, filed on Aug. 24, 2022.

(51) Int. Cl. H04L 1/00

(52) U.S. Cl. CPC H04L 1/0057; H04L 1/0041; H04L 1/0045

(57) ABSTRACT

Methods and apparatuses for UE cooperation in a retransmission scheme using cross-block check blocks are described. A first receiver node receives an initial transmission from a first transmitter node that includes a plurality of code blocks. The first receiver node decodes the plurality of code blocks. The first receiver node generates one or more cross-block check blocks using bits selected from across the plurality of code blocks. The first receiver node transmits, in a retransmission, at least one cross-block check block to a second receiver node, where the first receiver node and the second receiver node are both intended recipients of the initial transmission.

### CROSS-REFERENCE TO RELATED APPLICATION

This application is a continuation of International Application No. PCT/CN2022/114366, filed on Aug. 24, 2022, the disclosure of which is hereby incorporated by reference in its entirety.

### TECHNICAL FIELD

The present disclosure relates to methods and apparatuses for multicast, groupcast or broadcast wireless communications using HARQ-based retransmission schemes.

### BACKGROUND

Conventionally, Multimedia Broadcast Multicast Services (MBMS) in wireless broadcast and multicast transmissions have used a forward error correction (FEC) scheme known as fountain code (e.g., a fountain code known as Raptor code) to help address transmission error. The use of fountain code as an error correction scheme may be suitable for multicast and broadcast transmission because fountain code does not require feedback from a receiver. However, fountain code is designed for implementation at a higher layer than the physical (PHY) layer. Implementation of fountain code at the PHY layer results in increased latency as compared to other PHY layer error correction schemes, such as conventional hybrid automatic repeat request (HARQ) schemes. Further, since fountain code is a type of erasure code, its performance deteriorates in non-erasure channels.

Using conventional HARQ schemes offers reduced latency compared to fountain code scheme, however conventional HARQ is not suitable for broadcast and multicast services because conventional HARQ may introduce a significant feedback overhead penalty. For example, a conventional HARQ scheme may require the indices of erroneous code blocks (CB) or code block groups (CBG) at each receiver need to be communicated back to the transmitter, thus the conventional HARQ scheme may be inefficient if different CBs are in error at each receiver.

Accordingly, it would be useful to provide solutions for addressing transmission error in multicast, groupcast and broadcast communications.

### SUMMARY

In various examples, the present disclosure describes methods and apparatuses for multicast, groupcast and/or broadcast communications with user equipment (UE) cooperation, where cross-block check blocks are used in retransmissions. The disclosed retransmission scheme, which may be referred to as two-dimension (2D) HARQ, cross-block HARQ or vertical HARQ, among other possibilities, may enable more efficient retransmission (e.g., compared to conventional HARQ or fountain codes) and may enable more reliable transmissions.

The use of UE cooperation in broadcast, multicast or groupcast transmissions, such as MBMS, helps to improve the reliability of transmissions. The present disclosure provides example retransmission schemes that may be used together with such UE cooperation techniques. The present disclosure also provides examples of signaling that may be used to configure cooperation among multiple UEs that are intended recipients of an initial transmission. Examples of signaling for centralized cooperation or distributed cooperation are described.

Examples of the present disclosure may enable UEs to assist each other in decoding an initial transmission, without relying on a BS (or other network node) to be the source of retransmissions. This provides the technical advantage that retransmissions can be efficiently used to ensure reliable transmissions, even in scenarios where communications between a BS and the UEs are slow or inefficient (e.g., in the case of a non-terrestrial BS).

In an example aspect, the present disclosure describes a method at a first receiver node, the method including: receiving an initial transmission from a first transmitter node, the initial transmission comprising a plurality of code blocks; performing a decoding operation to decode the plurality of code blocks; generating one or more cross-block check blocks using bits selected from across the plurality of code blocks; and transmitting, in a retransmission, at least one cross-block check block to a second receiver node, the first receiver node and the second receiver node both being intended recipients of the initial transmission.

In an example of the preceding example aspect of the method, the method may further include: prior to the generating and transmitting, receiving, from the first transmitter node or a second transmitter node, configuration information one or more parameters for generating one or more cross-block check blocks; where the one or more cross-block check blocks may be generated in accordance with the indicated one or more parameters.

In an example of the preceding example aspect of the method, the method may further include: prior to receiving the configuration information, transmitting a positive acknowledgement (ACK) to the first transmitter node or the second transmitter node indicating decoding was successful; where the configuration information may be received in response to the ACK.

In an example of any of the preceding example aspects of the method, the first receiver node may be configured with an index indicating an order among a group of receiver nodes, and the at least one cross-block check block may be transmitted to the second receiver node in accordance with the indicated order.

In an example of a preceding example aspect of the method, the method may include: prior to the generating and transmitting, receiving, from the second receiver node, a negative acknowledgement (NACK) indicating decoding was not successful at the second receiver node; where the generating and transmitting may be performed in response to receipt of the NACK from the second receiver node.

In an example of the preceding example aspect of the method, the first receiver node may be configured with an index indicating an order of the first receiver node among a group of receiver nodes that are intended recipients of the initial transmission, and the at least one cross-block check block may be transmitted to the second receiver node in accordance with the indicated order.

In an example of the preceding example aspect of the method, the method may further include: prior to the transmitting, receiving, from a third receiver node that precedes the first receiver node in order among the group of receiver nodes, a control message indicating another retransmission performed by the third receiver node; where the transmitting may be performed following receipt of the control message.

In an example of the preceding example aspect of the method, the control message may further indicate which one or more cross-block check blocks is transmitted in the other retransmission performed by the third receiver node, and the transmitting may be performed to transmit at least one cross-block check block different from the one or more cross-block check blocks transmitted in the other retransmission.

In an example of any of the preceding example aspects of the method, the index may be associated with an assigned timeslot for performing the transmission, and the at least one cross-block check block is transmitted to the second receiver node at the assigned timeslot.

In an example of any of the preceding example aspects of the method, generating the set of one or more cross-block check blocks may include: determining a set of interleavers to use for selecting the bits from across the plurality of code blocks.

In an example of the preceding example aspect of the method, the set of interleavers may be associated with a redundancy version (RV) index.

In an example of the preceding example aspect of the method, the RV index may be randomly or pseudo randomly selected, or the RV index may be selected based on an index configured for the first receiver node.

In an example of some of the preceding example aspects of the method, a set of cross-block check blocks may be associated with the RV index, where the set of cross-block check blocks may be generated, and where the set of cross-block check blocks may be transmitted.

In an example of some of the preceding example aspects of the method, a set of cross-block check blocks may be associated with the RV index, where a subset of the set of cross-block check blocks may be generated a remaining one or more cross-block check blocks of the set of cross-block check blocks not being generated, and where the subset may be transmitted to the second receiver node by the first receiver node.

In an example of some of the preceding example aspects of the method, a set of cross-block check blocks may be associated with the RV index, where the set of cross-block check blocks may be generated, and where a subset of the set of cross-block check blocks may be transmitted to the second receiver node by the first receiver node, a remaining one or more cross-block check blocks of the set of cross-block check blocks not being transmitted to the second receiver node by the first receiver node.

In an example of some of the preceding example aspects of the method, the subset may be determined based on a fraction defined as a number of cross-block check blocks in the set of cross-block check blocks divided by a number of receiver nodes cooperating to transmit the plurality of cross-block check blocks to the second receiver node.

In an example of any of the preceding example aspects of the method, the at least one cross-block check block may be transmitted to the second receiver node over a sidelink channel.

In another example aspect, the present disclosure describes a method at a transmitter node, the method including: following transmission of an initial transmission to a plurality of intended recipients, receiving feedback from one or more of the intended recipients, the feedback indicating that at least a first one of the intended recipients was not successful at decoding the initial transmission; and configuring at least a second one of the intended recipients, which the feedback indicated was successful at decoding the initial transmission, to perform a retransmission to at least the first one of the intended recipients.

In an example of the preceding example aspect of the method, the configuring may include configuring at least the second one of the intended recipients with one or more parameters for generating one or more cross-block check blocks for the retransmission.

In an example of the preceding example aspect of the method, the configuring may include configuring at least the second one and a third one of the intended recipients to transmit different subsets of a same set of cross-block check blocks associated with a same redundancy version (RV) index in respective retransmissions.

In an example of a preceding example aspect of the method, the configuring may include configuring at least the second one and a third one of the intended recipients to generate different sets of cross-block check blocks associated with respective different redundancy version (RV) indexes.

In an example of any of the preceding example aspects of the method, feedback may be received from at least the second one of the intended recipients indicating at least the second one of the intended recipients has self-selected to perform the retransmission.

In an example of any of the preceding example aspects of the method, the method may further include: transmitting the initial transmission to the plurality of intended recipients.

In another example aspect, the present disclosure describes a method at a first receiver node, the method including: receiving an initial transmission from a first transmitter node, the initial transmission comprising a plurality of code blocks; performing a decoding operation to decode the plurality of code blocks, the decoding being unsuccessful; receiving, in a retransmission, at least one cross-block check block from a second receiver node, the first receiver node and the second receiver node both being intended recipients of the initial transmission; and performing another decoding operation using the received at least one cross-block check block to assist in decoding the plurality of code blocks.

In an example of the preceding example aspect of the method, the method may further include: receiving, in another retransmission, at least one different cross-block check block from a third receiver node, the first, second and third receiver nodes all being intended recipients of the initial transmission; where the other decoding operation may be performed using all cross-block check blocks received from both the first and the third receiver nodes to assist in decoding the plurality of code blocks.

In an example of any of the preceding example aspects of the method, the method may further include: following the unsuccessful decoding, transmitting, to the first transmitter node or a second transmitter node, a negative acknowledgement (NACK) indicating the decoding was unsuccessful; where the retransmission may be received following transmission of the NACK.

In an example of some of the preceding example aspects of the method, the method may further include: following the unsuccessful decoding, transmitting, to at least the second receiver node, a negative acknowledgement (NACK) indicating the decoding was unsuccessful; where the retransmission may be received following transmission of the NACK.

In another example aspect, the present disclosure describes an apparatus including: a processing unit; and a non-transitory memory including instructions that, when executed by the processing unit, cause the apparatus to perform the method of any one of the preceding example aspects of the method.

In another example aspect, the present disclosure describes a non-transitory computer readable medium having machine-executable instructions stored thereon, where the instructions, when executed by a processing unit of an apparatus, cause the apparatus to perform the method of any one of the preceding example aspects of the method.

In another example aspect, the present disclosure describes a computer program product comprising instructions which, when the program is executed by a computer, cause the computer to perform the method of any one of the preceding example aspects of the method.

In another example aspect, the present disclosure describes a processor of an apparatus, the processor configured to cause the apparatus to perform the method of any one of the preceding example aspects of the method.

In another example aspect, the present disclosure describes a system comprising a transmitter node, a first receiver node, and a second receiver node. The transmitter node is configured to transmit an initial transmission comprising a plurality of code blocks. The first receiver node is in communication with the transmitter node and is configured to receive the initial transmission. The first receiver node is further configured to transmit a retransmission comprising at least one cross-block check block generated from bits selected from across the plurality of code blocks of the received initial transmission. The second receiver node in communication with the transmitter node and the first receiver node. The second receiver node is configured to receive the initial transmission from the first transmitter node and receive the retransmission from the first receiver node.

### BRIEF DESCRIPTION OF THE DRAWINGS

Reference will now be made, by way of example, to the accompanying drawings which show example embodiments of the present application, and in which:

FIG. 1 illustrates an example wireless communication system, in which examples of the present disclosure may be implemented;

FIG. 2 illustrates an example apparatus that may be used to implement examples of the present disclosure;

FIGS. 3A-3D illustrate example code structures and cross-block check blocks, in accordance with example of the present disclosure;

FIG. 4 is a schematic diagram illustrating a simple example of multicast, broadcast or groupcast transmission with UE cooperation, in accordance with examples of the present disclosure;

FIGS. 5A-5C illustrate examples of UE cooperation using fractional retransmission, in accordance with examples of the present disclosure;

FIG. 6 illustrates an example of UE cooperation using full retransmission, in accordance with examples of the present disclosure;

FIGS. 7A-7C are signaling diagrams illustrating examples of signaling for centralized cooperation, in accordance with examples of the present disclosure;

FIGS. 8A-8B are signaling diagrams illustrating examples of signaling for distributed cooperation, in accordance with examples of the present disclosure;

FIG. 9 is a flowchart illustrating an example method that may be performed by a receiver node in the role of a cooperative UE, in accordance with examples of the present disclosure;

FIG. 10 is a flowchart illustrating an example method that may be performed by a transmitter node, in accordance with examples of the present disclosure; and

FIG. 11 is a flowchart illustrating an example method that may be performed by a receiver node in the role of a target UE, in accordance with examples of the present disclosure.

Similar reference numerals may have been used in different figures to denote similar components.

### DETAILED DESCRIPTION

To assist in understanding the present disclosure, an example wireless communication system is first described.

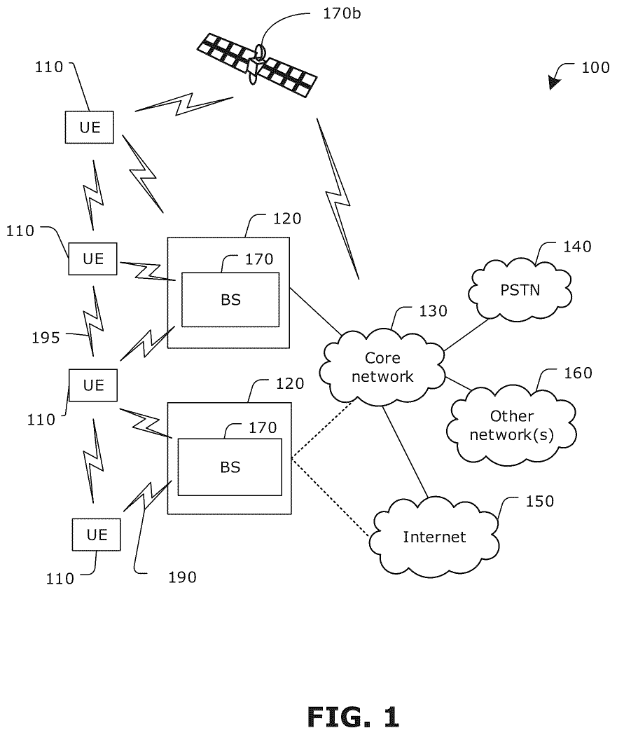

FIG. 1 illustrates an example wireless communication system 100 (also referred to as a wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, groupcast, multicast, narrowcast, device to device, etc.) among entities of the system 100. The wireless system 100 may operate by sharing resources such as bandwidth. The wireless system 100 may be suitable for wireless communications using 5G technology and/or later generation wireless technology. In some examples, the wireless system 100 may also accommodate some legacy wireless technology (e.g., 3G or 4G wireless technology).

In the example shown, the wireless system 100 includes user equipment (UEs) 110, radio access networks (RANs) 120, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The UEs 110 are configured to operate, communicate, or both, in the wireless system 100. For example, the UEs 110 may be configured to transmit, receive, or both via wireless or wired communication channels. The term “UE” may be used to refer to any suitable end user device for wireless operation and may include such devices (or may be referred to) as a wireless transmit/receive unit (WTRU), a mobile station, a mobile relay, a fixed or mobile subscriber unit, a cellular telephone, a station (STA), a machine type communication (MTC) device, a personal digital assistant (PDA), a smartphone, a laptop, a computer, a tablet, a wireless sensor, an internet of things (IoT) device, a network-enabled vehicle, or a consumer electronics device, among other possibilities. In some examples, the term electronic device (ED) may be used instead of UE. In general, it should be understood that the use of the term UE in the present disclosure does not necessarily limit the present disclosure to any specific wireless technology.

In FIG. 1, the RANs 120 include base stations (BSs) 170. Although FIG. 1 shows each RAN 120 including a single respective BS 170, it should be understood that any given RAN 120 may include more than one BS 170, and any given RAN 120 may also include base station controller(s) (BSC), radio network controller(s) (RNC), relay nodes, elements, and/or devices. FIG. 1 also depicts a non-terrestrial BS 170b, which may be part of a non-terrestrial network (not shown). A non-terrestrial BS 170b may also be referred to as a satellite. The non-terrestrial BS 170b may communicate with the core network 130 using satellite transmissions. A non-terrestrial BS 170b may wirelessly communicate with one or more UEs 110, similar to terrestrial BSs 170. Communications between a non-terrestrial BS 170b and a UE 110 (which is typically a terrestrial entity) may be slower compared to communications between a terrestrial BS 170 and a UE 110, due to the longer distance between a non-terrestrial BS 170b and a UE 110. For simplicity, a non-terrestrial BS 170b may be referred to as simply a BS 170, except where explicitly stated.

Each BS 170 is configured to wirelessly interface with one or more of the UEs 110 to enable access to any other BS 170, the core network 130, the PSTN 140, the internet 150, and/or the other networks 160. For example, the BSs 170 may also be referred to as (or include) a base transceiver station (BTS), a radio base station, a Node-B (NodeB), an evolved NodeB (eNodeB or eNB), a Home eNodeB, a gNodeB (gNB) (sometimes called a next-generation Node B), a transmission point (TP), a transmission and reception point (TRP), a site controller, an access point (AP), or a wireless router, among other possibilities. Future generation BSs 170 may be referred to using other terms. In some examples, the term TRP may be used to encompass a BS 170 or any other node that may serve to transmit and receive communications. Thus, although the present disclosure makes references to BSs 170, it should be understood that this is not intended to be limiting. Any UE 110 may be alternatively or additionally configured to interface, access, or communicate with any other BS 170, the internet 150, the core network 130, the PSTN 140, the other networks 160, or any combination of the preceding. In some examples, a BS 170 may access the core network 130 via the internet 150.

The UEs 110 and BSs 170 are examples of communication equipment that can be used to implement some or all of the functionality and/or embodiments described herein. Any BS 170 may be a single element, as shown, or multiple elements, distributed in the corresponding RAN 120, or otherwise. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. The number of networks (including terrestrial networks and non-terrestrial networks) shown is exemplary only. Any number of networks may be contemplated when devising the wireless system 100.

The BSs 170 communicate with one or more of the UEs 110 over one or more uplink (UL)/downlink (DL) wireless interfaces 190 (e.g., via radio frequency (RF), microwave, infrared, etc.). The UL/DL interface 190 may also be referred to as a UL/DL connection, UE-BS link/connection/interface, or UE-network link/connection/interface, for example. The UEs 110 may also communicate directly with one another (i.e., without involving the BS 170) via one or more sidelink (SL) wireless interfaces 195. The SL interface 195 may also be referred to as a SL connection, UE-to-UE link/connection/interface, vehicle-to-vehicle (V2V) link/connection/interface, vehicle-to-everything (V2X) link/connection/interface, vehicle-to-infrastructure (V2I) link/connection/interface, vehicle-to-pedestrian (V2P) link/connection/interface, device-to-device (D2D) link/connection/interface, or simply as SL, for example. The wireless interfaces 190, 195 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless communications.

The RANs 120 are in communication with the core network 130 to provide the UEs 110 with various services such as voice, data, and other services. The RANs 120 and/or the core network 130 may be in direct or indirect communication with one or more other RANs (not shown), which may or may not be directly served by core network 130, and may or may not employ the same radio access technology. The core network 130 may also serve as a gateway access between (i) the RANs 120 or UEs 110 or both, and (ii) other networks (such as the PSTN 140, the internet 150, and the other networks 160). In addition, some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or switch (not shown), and to the internet 150. PSTN 140 may include circuit switched telephone networks for providing plain old telephone service (POTS). The internet 150 may include a network of computers and subnets (intranets) or both, and incorporate protocols, such as Internet Protocol (IP), Transmission Control Protocol (TCP), User Datagram Protocol (UDP). The UEs 110 may be multimode devices capable of operation according to multiple radio access technologies, and incorporate multiple transceivers necessary to support such.

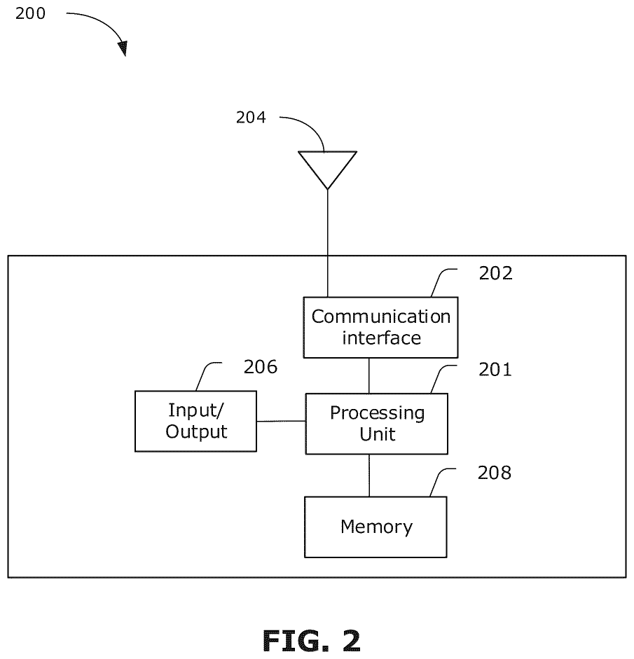

FIG. 2 illustrates an example apparatus 200 that may implement examples disclosed herein. FIG. 2 illustrates a possible embodiment for the UE 110 or the BS 170, and is not intended to be limiting.

As shown in FIG. 2, an example apparatus 200 (e.g., an example embodiment of the UE 110 or BS 170) includes at least one processing unit 201. The processing unit 201 implements various processing operations of the apparatus 200. For example, the processing unit 201 could perform signal coding, data processing, power control, input/output processing, or any other functionality of the apparatus 200. The processing unit 201 may also be configured to implement some or all of the functionality and/or embodiments described in more detail herein. Each processing unit 201 includes any suitable processing or computing device configured to perform one or more operations. Each processing unit 201 could, for example, include a microprocessor, microcontroller, digital signal processor, field programmable gate array, or application specific integrated circuit. Each of the at least one processing unit 201 may include one or more processor cores.

The apparatus 200 includes at least one communication interface 202 for wired and/or wireless communications. One or multiple communication interfaces 202 could be used in the apparatus 200. Each communication interface 202 includes any suitable structure for generating signals for wireless or wired transmission and/or processing signals received wirelessly or by wire. Although shown as a single functional unit, the communication interface 202 could also be implemented using at least one transmitter interface and at least one separate receiver interface. In some examples, one or more transmitters and one or more receivers may be implemented by the communication interface 202.

The apparatus 200 includes one or more antennas 204 for wireless communications. Each antenna 204 includes any suitable structure for transmitting and/or receiving wireless signals. In some examples, the apparatus 200 may include multiple antennas 204 to support multiple-input multiple-output (MIMO) communications. There may be multiple antennas 204 that together form an antenna array, which may be used for beamforming and beam steering operations. In some examples, there may be one or more antennas 204 used for transmitting signals and separate one or more antennas 204 used for receiving signals.

The apparatus 200 further includes one or more input/output devices 206 or input/output interfaces (such as a wired interface to the internet 150). The input/output device(s) 206 permit interaction with a user or other devices in the wireless system 100. Each input/output device 206 includes any suitable structure for providing information to or receiving information from a user, such as a speaker, microphone, keypad, keyboard, display, or touchscreen, including network interface communications.

In addition, the apparatus 200 includes at least one memory 208. The memory 208 stores instructions and data used, generated, or collected by the apparatus 200. For example, the memory 208 could store software instructions or modules configured to implement some or all of the functionality and/or embodiments described herein and that are executed by the processing unit(s) 201. Each memory 208 includes any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

In wireless communication systems, a BS 170 may transmit data (e.g., a transport block (TB)) to one or more UEs 110. A TB can be segmented and encoded by forward error correction (FEC) codes to generate multiple code blocks (CBs) for transmission. Additionally, several CBs in TB can be grouped to form a code block group (CBG). The FEC code used to encode the CB can be a systematic or non-systematic code. If a systematic code is used, the CB includes both information bits (also referred to as systematic bits) and check bits (also referred to as parity bits) The information bits represent the data, while the check bits represent the redundancy bits calculated and added by the FEC code for error correction. If a non-systematic code is used, the CB does not contain information bits (i.e., only check bits are included in the CB).

Hybrid automatic repeat request (HARQ) is a commonly used retransmission technique. Conventional HARQ retransmission schemes are typically based on whether a TB was successfully decoded by a receiver node. If the receiver node was unsuccessful in decoding even one CB of a packet (where a packet may be a single TB), then negative feedback is sent back to the transmitter node and the transmitter node performs a retransmission of the entire packet, even if other CBs of the packet were successfully decoded by the receiver node. This may be an inefficient use of communication resources. In New Radio (NR) Release 15, CBG based HARQ retransmission is supported. In CBG based HARQ retransmission, CBs are grouped in CBGs, and feedback from the receiver node includes the index of the CBG containing the CB that was not successfully decoded. Then the retransmission can be based on only the CBG having the index indicated in the feedback. However, CBG based HARQ retransmission requires the feedback to include the CBG index that needs to be retransmitted, which increases the overhead of the HARQ feedback. Further, in the case where each CGB has one (or more) CB in error, all CBGs (i.e., the entire TB) are used for the retransmission thus there would be no savings in retransmission, in addition to the added overhead of having to feedback the CBG indexes. As such, CBG based HARQ still may result in inefficiencies.

Retransmission schemes based on the use of cross-block check blocks (also referred to as cross-packet check blocks or vertical check blocks) have been described. For example, techniques for generating cross-block check blocks have been described in U.S. patent application Ser. No. 16/665,121, entitled “SYSTEM AND METHOD FOR HYBRID-ARQ”, filed Oct. 28, 2019, the entirety of which is hereby incorporated by reference. The use of cross-block check blocks in network coding (also referred to as 2D network coding or 2D joint network coding) has been described in U.S. patent application Ser. No. 17/110,226, entitled “METHODS AND SYSTEMS FOR NETWORK CODING USING CROSS-PACKET CHECK BLOCKS”, filed Dec. 2, 2020, the entirety of which is hereby incorporated by reference.

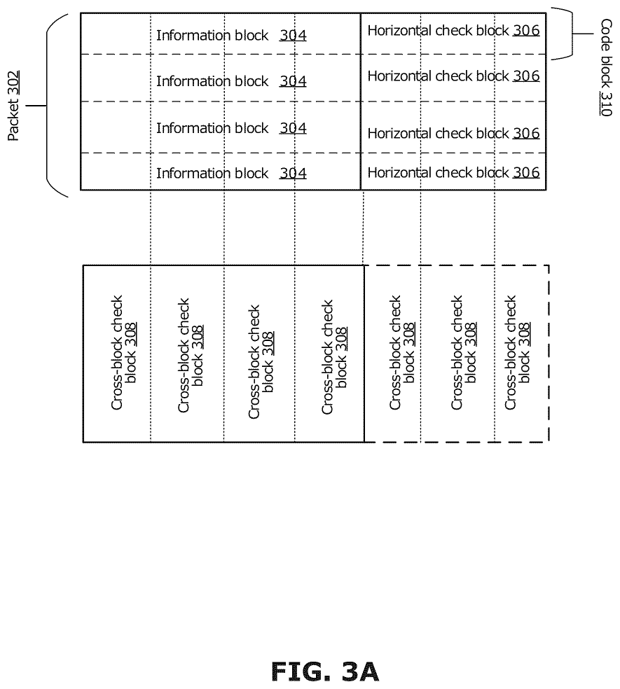

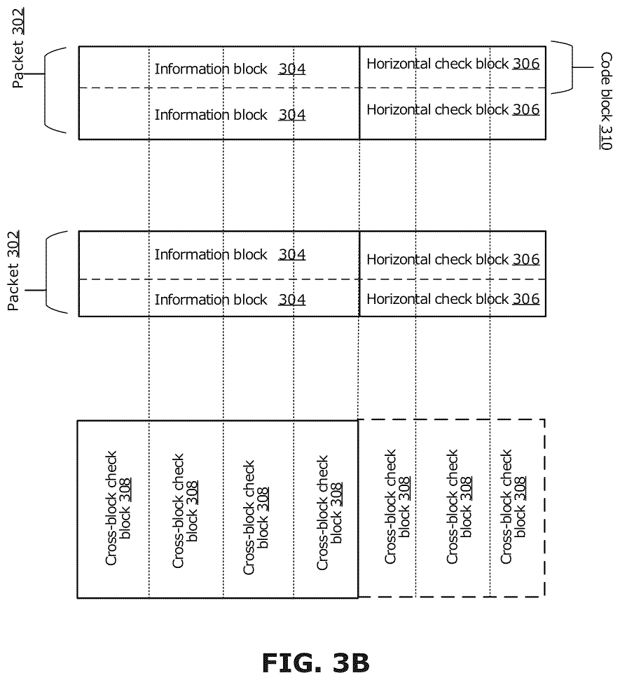

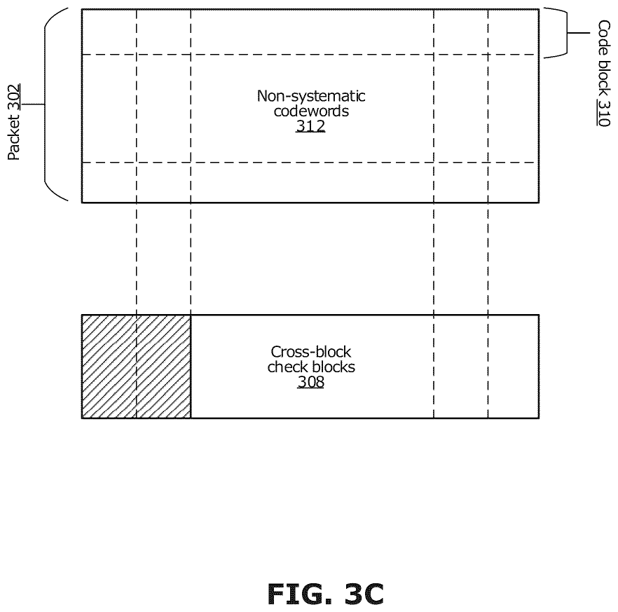

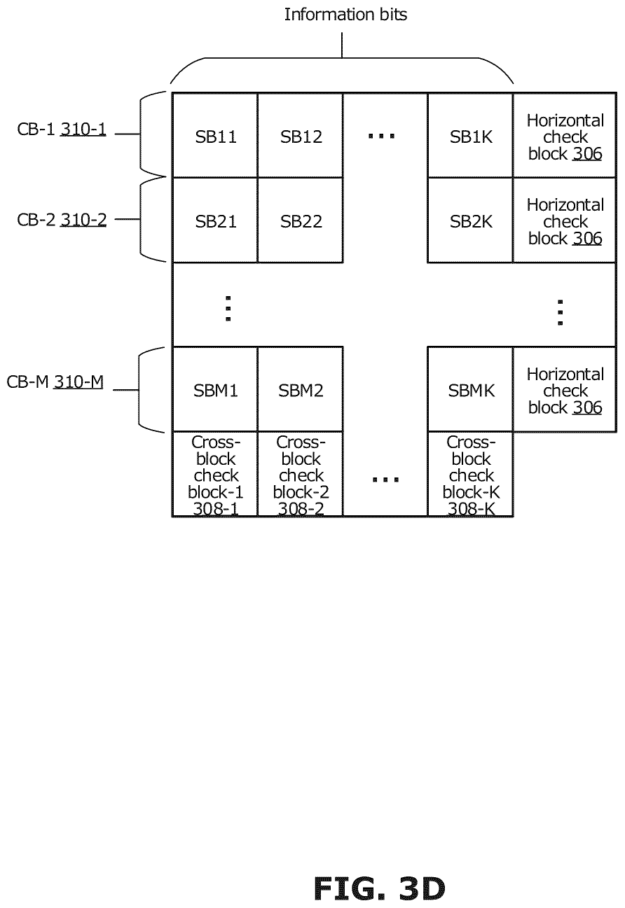

Examples of how cross-block check blocks may be generated are now described with reference to FIGS. 3A-3C.

FIG. 3A illustrates an example code structure for a single packet 302 (which may be one TB) that is segmented into multiple CBs 310 (in this example, four CBs 310 are shown for simplicity, however this is not intended to be limiting). Each CB 310 includes an information block 304 formed from encoder input bits. The encoder input bits may also be referred to as information bits. Each CB 310 also includes check bits (e.g., cyclic redundancy check (CRC) bits) generated using the bits from the information block 304 of the CB 310. The check bits, which are appended to the information block 304 of the CB 310, may be referred to as a horizontal check block 306. As shown, there may be one horizontal check block 306 in each CB 310. The term “horizontal” refers to how the check bits in the horizontal check block 306 are generated using only the information bits from a single CB 310, and is not intended to imply any physical structure or orientation. A horizontal check block 306 may also be referred to as an intra-block check block or a single-CB check block, among other possibilities.

One or more cross-block check blocks 308 are generated using bits selected from across two or more CBs 310. In some examples, cross-block check blocks 308 may be referred to as vertical check blocks (to distinguish from the horizontal check blocks 306), however the term “vertical” is not intended to imply any physical structure or orientation. Further, it should be understood that the terms “parity block” or “redundancy block” may also be used instead of “check block”. In FIG. 3A, each cross-block check block 308 is generated using bits selected from across two or more CBs 310 of the packet 304.

FIG. 3B illustrates another example, which is similar to that of FIG. 3A with the difference that FIG. 3B illustrates two different packets 302 and the cross-block check blocks 308 are generated using bits selected from across the CBs of the two different packets 302. Although two packets 302 are shown, it should be understood that there may be more packets 302. Thus, FIG. 3B illustrates an example in which each cross-block check block 308 is generated using bits selected from across the CBs 310 of two or more packets 302. In this example, the cross-block check blocks 308 may also be referred to as cross-packet check blocks (because the cross-block check blocks 308 are generated using bits selected from across two or more packets 302).

FIG. 3C illustrates another example, which illustrates how cross-block check blocks 308 may be generated from non-systematic code (e.g., Polar code, block code, or convolutional code). The packet 302 is segmented into a plurality of CBs 310, where each CB 310 is a non-systematic codeword 312. Each non-systematic codeword is determined based on a set of encoder input bits, but the information bits do not appear in the codeword as systematic bits. Unlike systematic codes, horizontal check bits are not simply appended to a set of information bits. In this example, a single packet 302 is shown however it should be understood that there may be more than one packet 302 (each packet 302 containing CBs 310 with non-systematic codewords 312). In this example, each cross-block check block 308 is generated using bits selected from cross two or more CBs 310.

It will be appreciated by persons skilled in the art that the present disclosure is not dependent on whether systematic or non-systematic code is used. For simplicity, the following discussion may be based packets 302 having systematic CBs 310. It should be understood that this is not intended to be limiting.

When systematic CBs 310 are used, the cross-block check blocks 308 may include one or more cross-block check blocks 308 generated from bits selected across multiple information blocks 304. Optionally, one or more cross-block check blocks 308 may also be generated using bits selected from across multiple horizontal check blocks 306. Cross-block check blocks 308 generated from bits selected from horizontal check blocks may be referred to as “check on check” blocks.

In general, in each of the examples of FIGS. 3A-3C, each cross-block check block 308 is generated from bits selected across multiple CBs 310. In particular, one or more bits may be selected from each of two or more CBs 310. The selected bits may be referred to as cross-block bits (because the bits are selected from across multiple CBs 310), and the group of selected bits may be referred to as the cross-block information block. The cross-block information block is then encoded (e.g., using a FEC code, such as LDPC code) or otherwise combined (e.g., using XOR, linear combination, etc.) to obtain the cross-block check block 308. In general, the term check block should be understood to encompass various techniques that may be used to combine bits selected from across different CBs 310, including using XOR or using a linear combination of bits as well as encoding techniques such as encoding the selected bits using a channel code (among other possibilities).

When CBs 310 are arranged in rows, as shown in FIGS. 3A-3C, each cross-block check block 308 may be generated from a column of bits, where the column of bits may have any suitable width (e.g., may be one or more bits wide). Different cross-block check blocks 308 may be generated from columns of different bit widths (i.e., different cross-block check blocks 308 may be generated using different numbers of cross-block bits). In some examples, each CB 310 may be divided into equal (or approximately equal) number of bits, referred to as subblocks. Then each cross-block check block 308 may be generated from bits belonging to a respective column of subblocks.

FIG. 3D illustrates an example code structure with M CBs 310 (namely CB-1 310-1, CB-2 310-2 to CB-M 310-M, where M is a positive integer). The bits in each CB 310 are split into a plurality of subblocks, where the k-th subblock for the i-th CB is denoted as SBik. In this example, each CB 310 is divided into K subblocks, where K is a positive integer, for a total of M×K subblocks in the code structure. It should be noted that the number of bits in each subblock is not necessarily equal across all subblocks (e.g., the number of bits in a CB 310 may not be equally divisible by K). In other examples, the number of bits in each subblock may be significantly different (e.g., each CB 310 may be arbitrarily divided into a plurality of subblocks). A subblock from each CB 310 is combined together to generate a cross-block check block 308 (e.g., using FEC). In particular, the k-th subblock from each CB 310 is used to generate the k-th vertical code block. In the example shown, SB11, SB21 . . . SBM1 are combined to generate cross-block check block-1 308-1; SB12, SB22 . . . SBM2 are combined to generate cross-block check block-2 308-2; and so forth until SB1K, SB2K . . . SBMK are combined to generate cross-block check block-K 308-K. Thus, in this example, the number of cross-block check blocks generated is equal to the number of subblocks per CB 310; however this is not intended to be limiting.

A set of cross-block check blocks 308 may be generated based on the subblocks of the CBs 310 in their natural order, as shown in FIG. 3D. The “natural order” may refer to the order of bits in each CB 310 as outputted by the encoder. A different set of cross-block check blocks 308 may be generated by shuffling (or interleaving) the subblocks within each CB 310 (such that the vertical columns of subblocks that are obtained after the shuffling or interleaving are different from the vertical columns of bits that are obtained when the subblocks of the CBs 310 are in their natural order). A predefined shuffling scheme or predefined interleaver may be used to perform this shuffling or interleaver. An interleaver may be a predefined algorithm or predefined matrix (among other possibilities) that is applied to the row of subblocks to obtain a reordered row of subblocks. It should be understood that other techniques (not necessarily limited to interleaving) may be used. Different sets of cross-block check blocks 308 may be thus generated for the same set of CBs 310, using the subblocks in their natural order or using different interleavers.

It should be noted that, in order for a given set of cross-block check blocks 308 to be useful for decoding the CBs 310, it is necessary for the receiver node to know the subblock interleavers that were used to generate the given set of cross-block check blocks 308. Generally, in a retransmission scheme, different retransmissions are characterized by different RVs indices. In some examples, the interleavers that are used to generate each set of cross-block check blocks 308 may be associated with specific RV indices and this association may be predefined (e.g., in a standard, or preconfigured by signaling) and known to both the transmitter node and the receiver node. Thus, if the receiver node knows the RV index of a given retransmission, the receiver node can also determine the interleaver used for generating the set of cross-block check blocks 308 in the given retransmission.

Examples of how each RV index may be associated with a respective interleaver used for generating cross-block check blocks 308 are described in PCT application no. PCT/CN2021/121483, “METHODS AND APPARATUSES FOR WIRELESS COMMUNICATION RETRANSMISSION USING CHECK BLOCKS GENERATED ACCORDING TO SUBBLOCK INTERLEAVERS”, filed Sep. 28, 2021, the entirety of which is hereby incorporated by reference.

The manner in which cross-block bits are selected (e.g., which interleaver or RV index to use, how many bits to select across different CBs 310, which CBs 310 from which to select the cross-block bits, etc.) and the manner in which the cross-block check blocks 308 are generated (e.g., what combination or encoding technique to use, how many cross-block check blocks 308 to generate, whether check-on-check blocks are generated, etc.) may be configured by the transmitter node and/or by a network controller, and/or may be defined by a standard.

The check bits contained in the horizontal check blocks 306 and cross-block check blocks 308 are useful to assist decoding at a receiver node. For example, after each decoding operation (also referred to as a decoding attempt) at a decoder, error checking can be performed using check bits to determine if the information bits in the CB 310 have been successfully decoded. Each cross-block check block 308 contains check bits generated from across multiple CBs 310, and thus provides information useful for decoding multiple CBs 310. The decoder may use the check bits of the cross-block check block 308 to assist in decoding of a CB 310.

In examples where the CBs 310 are systematic (such as LDPC code or Turbo code), an iterative decoding process may be used at the decoder at the receiver node to decode the received CBs 310. The decoder calculates log-likelihood ratios (LLRs) of bit values during decoding of the CBs 310, which may be considered a “soft” output of the decoder. In the present disclosure, soft output may refer to decoder output that is not yet finalized (e.g., bit value not yet definitively determined to be 1 or 0 value) but may provide information that can still be useful (e.g., in a subsequent decoding iteration). Such soft output may be probabilistic in nature (e.g., LLR). CBs 310 that are not correctly decoded (e.g., fails a check using the corresponding horizontal check blocks 306) may benefit from information encoded in the cross-block check blocks 308. Because each of the cross-block check blocks 308 is generated from information bits selected from two or more (or all) of the CBs 310, soft output from decoding operations to decode a cross-block check block 308 may help to improve decoding of the CBs 310 (and vice versa). In at least this way, cross-block check blocks 308 help to improve decoding.

A HARQ retransmission scheme that makes use of cross-block check blocks may be referred to as cross-block HARQ or 2D HARQ. A HARQ retransmission scheme that does not make use of cross-block check blocks may be referred to as conventional HARQ or 1D HARQ. The present disclosure describes example retransmission schemes that enables UEs to cooperate with each other when using cross-block check blocks in retransmissions.

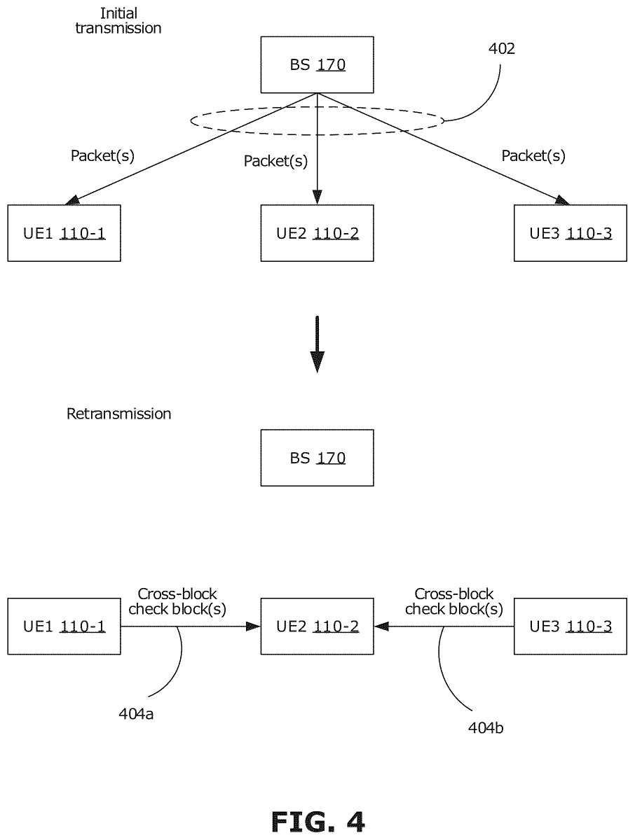

FIG. 4 is a schematic diagram illustrating a simple example of multicast, broadcast or groupcast transmission with UE cooperation for retransmission. In this simple example, a single BS 170 is shown as the transmitter node, and three UEs 110 (namely UE1 110-1, UE2 110-2 and UE3 110-3, generically referred to as UE 110) are shown as the receiver nodes in the group of intended recipients. The BS 170 may be a terrestrial or non-terrestrial BS. Each UE 110 is capable of SL communications with at least one other UE 110 over available SL channels and/or capable of device-to-device communications with at least one other UE 110.

The BS 170 transmits an initial transmission 402 (e.g., a broadcast, groupcast or multicast transmission) to a plurality of UEs 110. The initial transmission 402 includes a set of one or more packets (with a plurality of CBs). In this example, UE1 110-1 and UE3 110-3 successfully decode all the CBs of the packet(s), but UE2 110-2 fails to successfully decode all the CBs of the packet(s). Each of UE1 110-1 and UE3 110-3 then transmits a respective retransmission 404a, 404b to UE2 110-2. Each retransmission 404a, 404b contains one or more cross-block check block(s) that is generated by the respective UE1 110-1, UE3 110-3 using the successfully decoded packet(s). UE2 110-2 may then use the received cross-block check block(s) to assists its own decoding of the packet(s).

In the present disclosure, UEs 110 that have successfully decoded the packet(s) from an initial transmission (i.e., UE1 110-1 and UE3 110-3 in this example) may be referred to as cooperative UEs (CUEs) and UEs 110 that have not successfully decoded the packet(s) from an initial transmission (i.e., UE2 110-2 in this example) may be referred to as target UEs (TUEs). There may be one or more CUEs and one or more TUEs, and the number of CUEs may be greater than, fewer than or equal to the number of TUEs. In general, CUEs may assist TUEs to decode packet(s) by the CUEs generating cross-block check block(s) from its successfully decoded packet(s) and the CUEs transmitting the cross-block check block(s) to the TUEs, as disclosed herein. It should be noted that the terms CUE and TUE merely refer to the role performed by a given UE 110 for a given retransmission. A UE 110 may act as a TUE in one retransmission and may act as a CUE in another retransmission. The number of CUEs and the particular UEs participating as CUEs in a retransmission may change from between retransmissions (e.g., a UE that participates as a CUE in a first retransmission may not participate as a CUE in an immediately following second retransmission). In other words, each UE 110 may have capabilities for performing the functions of a CUE as well as the functions of a TUE. As such, the terms CUE and TUE are not intended to limit a UE 110 to a particular hardware embodiment. Other terms may be used instead of CUE and TUE (e.g., a CUE may be referred to as an assisting UE and a TUE may be referred to as an assisted UE, among other possibilities).

The operation of a CUE to assist a TUE by performing one or more retransmissions may be a type of UE cooperation. A CUE may transmit one or more cross-block check blocks (over one or more retransmissions) to a TUE using a SL channel or using a device-to-device interface, for example. The CUE may perform the retransmission as a multicast, broadcast or groupcast transmission, for example.

In general, if there are K UEs 110 that have successfully decoded the CBs of an initial transmission transmitted to a group of intended recipient UEs 110, this means there can be up to K CUEs. If there are more than two CUEs cooperating to provide cross-block check blocks to a TUE, there may be benefits due to increased spatial diversity. For example, cross-block check blocks transmitted by different CUEs may experience different channel conditions, thus leading to possible improved performance due to spatial diversity.

It may be assumed that all UEs 110 that successfully decoded the initial transmission participate as CUEs in a retransmission. However, in other examples, a UE 110 that successfully decoded an initial transmission may not participate as a CUE in a retransmission. For example, a UE 110 that is low on power, that has limited processing power and/or that has limiting transmitting resources may decide not to participate as a CUE.

As previously mentioned, a set of cross-block check block(s) may be generated using a set of interleavers, where the set of interleavers is associated with a particular RV index (with the RV index 0 being reserved for the initial transmission, in some examples). Thus, configuring the CUE with a particular RV index for a given retransmission may implicitly also configure the CUE to generate the set of cross-block check block(s) using the particular set of interleavers that is associated with the RV index. As such, in some examples, reference to the RV index may be used as shorthand for the set of interleavers. For example, “a set of cross-block check block(s) for RV1” may be shorthand for “a set of cross-block check block(s) generated using the set of interleavers that is associated with RV index 1”.

The CUE may be configured (e.g., by control signaling, discussed further below) with the RV index to use for a particular retransmission. The CUE may also be configured with other parameters to use for generating the set of cross-block check block(s) and/or for performing the retransmission (e.g., the CBs to use for generating the cross-block check block(s), the number of cross-block check block(s) to generate, the number and/or indexes of cross-block check block(s) to transmit in the retransmission, etc.).

In some examples, two or more CUEs may cooperate to provide the TUE with cross-block check blocks. For example, each CUE may generate and transmit to the TUE a respective set of cross-block check block(s) that is generated using the set of interleavers associated with a respective RV index (e.g., a first CUE may generate cross-block check block(s) using the interleavers associated with RV index 1; and a second CUE may generate cross-block check block(s) using the interleavers associated with RV index 2). In another example, two or more CUEs may each generate a respective subset of cross-block check blocks belonging to the same set of cross-block check blocks. For example, each CUE may use the interleavers associated with the same RV index, but instead of generating the entire set of cross-block check blocks each CUE may generate a different subset of the cross-block check blocks to be transmitted to the TUE. Alternatively, each CUE may generate the entire set of cross-block check blocks using the same RV index, but may transmit only a subset of the generated cross-block check blocks to the TUE.

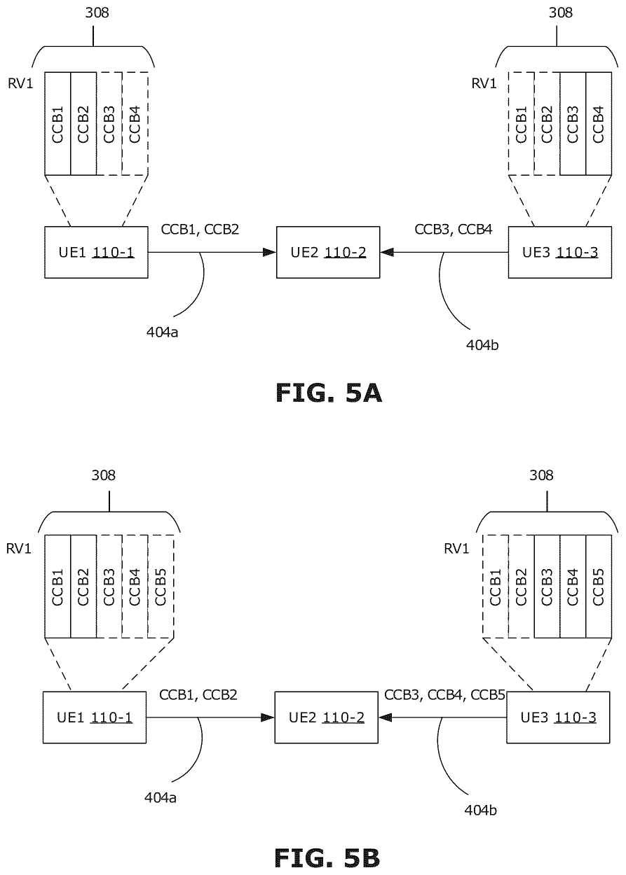

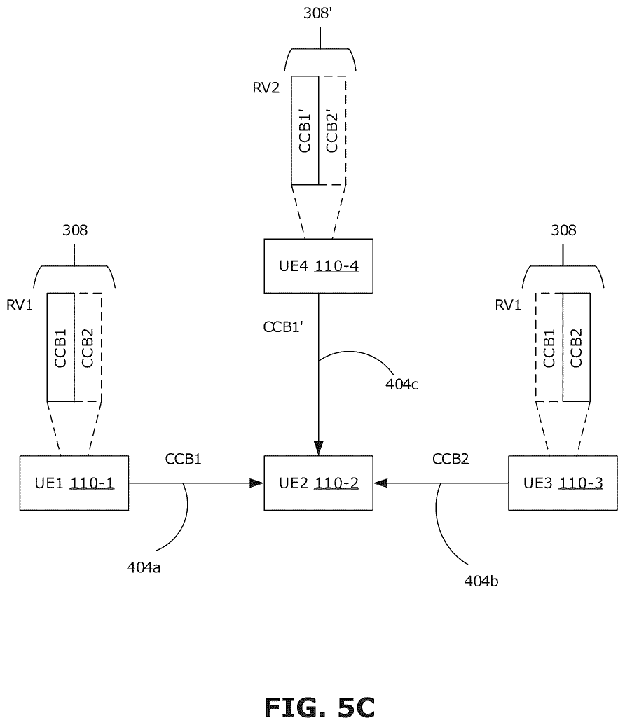

FIGS. 5A-5C illustrate some examples in which two or more CUEs cooperate to transmit different subsets of a set of cross-block check blocks to the TUE. For simplicity, FIGS. 5A-5C only illustrate one retransmission and omits the initial transmission (e.g., from a BS 170) and any additional retransmissions. In some examples, the division of cross-block check blocks among two or more CUEs may be referred to as fractional retransmission.

In an example of fractional retransmission, each CUE may transmit a respective fraction of the same set of cross-block check blocks to the TUE. For example, consider the case where there are K CUEs and there are N cross-block check blocks that can be generated using a given RV index (i.e., the set of interleavers associated with the RV index is designed to generate a set of cross-block check blocks having a certain number N of cross-block check blocks in the generated set). In other words, the set of cross-block check blocks associated with the given RV index contains N cross-block check blocks in total. Any selection of fewer than N cross-block check blocks may thus be referred to as a subset of the cross-block check blocks associated with the given RV index. Each CUE may generate a respective N/K number of cross-block check blocks using the same RV index (i.e., each CUE generates a respective subset of the set of N cross-block check blocks) and transmits the generated N/K number of N/K cross-block check blocks to the TUE. An example of this is illustrated in FIG. 5A.

In the simple example of FIG. 5A, UE1 110-1 and UE3 110-3 have successfully decoded an initial transmission and act as CUEs to assist UE2 110-2 (which is considered the TUE). Each of UE1 110-1 and UE3 110-3 generates a respective subset of the same set of cross-block check blocks 308 (in this example, using the set of interleavers associated with RV index 1, indicated as “RV1”). The set of cross-block check blocks 308 in this example contains four cross-block check blocks 308, designated CCB1 to CCB4. Since there are two CUEs and four cross-block check blocks 308 in the set of cross-block check blocks associated with RV1, N=4 and K=2. As shown in FIG. 5A, UE1 110-1 may generate only CCB1 and CCB2 from the set of cross-block check blocks 308. CCB3 and CCB4 may not be generated, or may be generated and discarded by UE1 110-1, thus CCB3 and CCB4 are indicated as being optional (using dashed lines) at UE1 110-1. UE3 110-3 generates a different subset from the set of cross-block check blocks 308, namely CCB3 and CCB4 (with CCB1 and CCB2 being not generated, or generated and discarded at UE3 110-3 as indicated using dashed lines). Thus each of UE1 110-1 and UE3 110-3 transmits a respective subset of two cross-block check blocks 308 in respective retransmissions. In this example, UE1 110-1 transmits CCB1 and CCB2 in the retransmission 404a, and UE3 110-3 transmits CCB3 and CCB4 in the retransmission 404b. Notably, each CUE (i.e., UE1 110-1 and UE3 110-3) transmits a different subset of the set of cross-block check blocks 308 associated with RV1.

In some cases, the number N of cross-block check blocks in the set of cross-block check blocks associated with a given RV index may not be equally divisible by the number of CUEs (i.e., N/K is not an integer). In such cases, the number of cross-block check blocks generated and transmitted by the different CUEs may be unequal. For example, as illustrated in the example of FIG. 5B, if there are five cross-block check blocks 308 in the set associated with RV1 and two CUEs (i.e., N=5 and K=2), then UE1 110-1 may transmit two cross-block check blocks (i.e., CCB1 and CCB2 in this example; with CCB3, CCB4 and CCB5 being not generated, or optionally generated and discarded as indicated by dashed lines) while UE3 110-3 may transmit the remaining three cross-block check blocks (i.e., CCB3, CCB4 and CCB5; with CCB1 and CCB2 being not generated, or optionally generated and discarded as indicated by dashed lines).

In some cases, the number K of CUEs may be larger than the number N of cross-block check blocks (i.e., K>N) in the set associated with a given RV index. In such cases, the first N CUEs may each transmit one of the set of N cross-block check blocks associated with a first RV index (e.g., RV index 1), while the remaining CUEs may transmit cross-block check blocks associated with a different RV index (e.g., RV index 2).

FIG. 5C illustrates the example where there are three CUEs (namely UE1 110-1, UE3 110-3 and UE4 110-4), thus K=3. However, in this example, the set of cross-block check blocks 308 associated with RV index 1 contains only two cross-block check blocks 308, namely CCB1 and CCB2 (i.e., N=2; thus K>N). Thus, each of UE1 110-1 and UE3 110-3 performs a respective retransmission 404a, 404b with a respective different one generated cross-block check block. In this example, UE1 110-1 generates CCB1 (with CCB2 being optionally generated and discarded) and transmits CCB1 in the retransmission 404a; and UE3 110-3 generates CCB2 (with CCB1 being optionally generated and discarded) and transmits CCB2 in the retransmission 404b. The remaining UE4 110-4 generates a subset of a different second set of cross-block check blocks 308′ associated with a different RV index (in this example, RV index 2, indicated as “RV2”). As shown in this example, the cross-block check blocks 308′ associated with RV index 2 are CCB1′ and CCB2′. UE4 110-4 generates CCB1′ (with CCB2′ being optionally generated and discarded) then transmits CCB1′ in a retransmission 404c to UE2 110-2. Notably, the retransmissions 404a and 404b from UE1 110-1 and UE2 110-2 have the same RV index (i.e., RV index 1 in this example) and the retransmission 404c from UE4 110-4 has a different RV index (i.e., RV index 2 in this example).

It should be understood that there are various ways in which fractional retransmission may be implemented, and the present disclosure is not intended to be limited to the specific examples discussed herein.

In some examples, instead of performing fractional retransmission, each CUE may perform a retransmission by generating and transmitting the full set of cross-block check blocks 308 associated with a respective different RV index. Each CUE may generate a respective different set of cross-block check blocks 308 by using a respective different set of interleavers (associated with respective different RV indexes). Such a scheme may be referred to as full retransmission. A UE 110 may have capabilities for operation as a CUE using fractional retransmission schemes as well as using full retransmission schemes. The UE 110 may be provided with configuration information (e.g., via control signals or control messages, discussed further below) to enable the UE 110 to operate as a CUE in a fractional retransmission scheme or as a CUE in a full retransmission scheme.

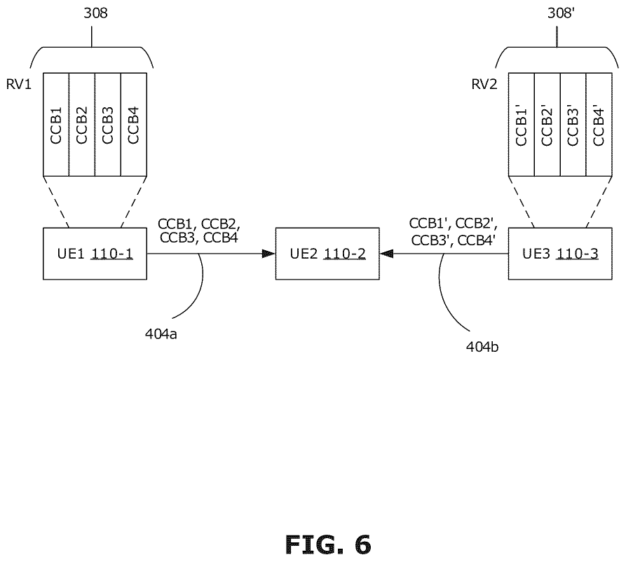

FIG. 6 illustrates an example in which two or more CUEs cooperate to transmit different sets of cross-block check blocks, generated using different interleavers associated with different RV indexes, to the TUE. For simplicity, FIG. 6 only illustrates one retransmission and omits the initial transmission (e.g., from a BS 170) and any additional retransmissions.

In the simple example of FIG. 6, UE1 110-1 and UE3 110-3 have successfully decoded an initial transmission and act as CUEs to assist UE2 110-2 (which is considered the TUE). UE1 110-1 generates a first set of cross-block check blocks 308 using a first set of interleavers associated with a first RV index (in this example, RV index 1, indicated as “RV1”). UE3 110-3 generates a second set of cross-block check blocks 308′ using a second set of interleavers associated with a second RV index (in this example, RV index 2, indicated as “RV2”). In this example, both the first set of cross-block check blocks 308 and the second set of cross-block check blocks 308′ each has four cross-block check blocks (designated CCB1 to CCB4 and CCB1′ to CCB4′, respectively). However, in other examples the number of cross-block check blocks may be different between the first and second sets. UE1 110-1 transmits the full first set of cross-block check blocks 308 (i.e., CCB1 to CCB4, in this example) in a retransmission 404a to UE2 110-2, and UE3 110-3 transmits the full second set of cross-block check blocks 308′ (i.e., CCB1′ to CCB4′, in this example) in a retransmission 404b to UE2 110-2. It may be noted that the retransmission 404a by UE1 110-1 and the retransmission 404b by UE3 110-3 may be performed at different assigned timeslots, to avoid collision. In some examples, instead of using different timeslots, the retransmissions 404a, 404b may use different frequency resources but may overlap in time.

Compared to the fractional retransmission scheme (e.g., as illustrated in FIGS. 5A-5C), the full retransmission scheme (e.g., as illustrated in FIG. 6) may enable reduced latency. In the full retransmission scheme, the entire set of cross-block check blocks 308 that is associated with a given RV index can be transmitted by a single CUE. This means that one retransmission by one CUE may provide the same amount of information to assist the TUE in decoding the initial transmission as the amount of information provided over multiple retransmissions using fractional retransmission (in which multiple retransmissions from multiple CUEs is required to provide the entire set of cross-block check blocks 308 associated with a given RV index). On the other hand, the full retransmission scheme may provide less diversity gain and may require the use of more retransmission resources compared to the fractional retransmission scheme.

Configuration information may be used to configure UEs 110 to participate as CUEs in a UE cooperative retransmission scheme (e.g., using fractional retransmission or full retransmission). In some examples, which may be referred to as centralized cooperation, a centralized entity (e.g., a BS 170) may provide configuration information to each CUE. In other examples, which may be referred to as distributed cooperation, each CUE may itself determine (independently and/or in collaboration with other CUEs) the configuration to use.

Examples of centralized cooperation are first discussed. As mentioned above, in the centralized cooperation a centralized entity (e.g., a network node such as a BS 170) determines the configuration information for each CUE, including parameters to use for generating cross-block check blocks 308 (e.g., which CBs of the initial transmission to use to generate the cross-block check blocks 308, which RV index (and hence which set of interleavers) to use, etc.) and the timing for each CUE to perform a respective retransmission. It should be noted that the centralized entity for controlling the centralized cooperation may or may not be the same as the transmitter node that performed the initial transmission. For example, a first BS 170 that performs the initial groupcast, multicast or broadcast may be different from a second BS 170 that provides control signaling to the CUEs. The first BS 170 for the initial groupcast, multicast or broadcast transmission and the second BS 170 for controlling the centralized cooperation may be pre-configured and determined prior to the initial transmission. Pre-configuration of a BS 170 may be performed in various ways know to those skilled in the art, and need not be discussed in detail here.

In some examples, the first BS 170 performing the initial transmission and the second BS 170 providing the control signaling may be different terrestrial network (TN) or non-terrestrial network (NTN) nodes. For example, the initial transmission may be performed by a non-terrestrial BS 170b of an NTN, and the control signaling may be provided by a terrestrial BS 170 of a TN. This may be useful because a terrestrial BS 170 may receive feedback from and provide control signaling to terrestrial UEs 110 with lower latency than a non-terrestrial BS 170b. For simplicity and to reduce redundancy, the following discussion will make reference to the BS 170 that provides the control signaling, with the understanding that this BS 170 may be the same as or different from the BS 170 that performed the initial transmission.

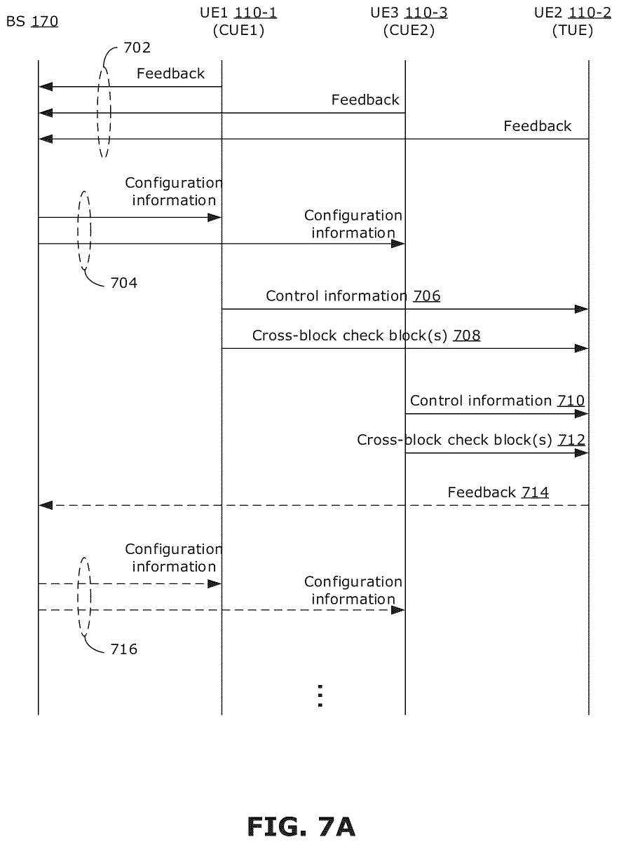

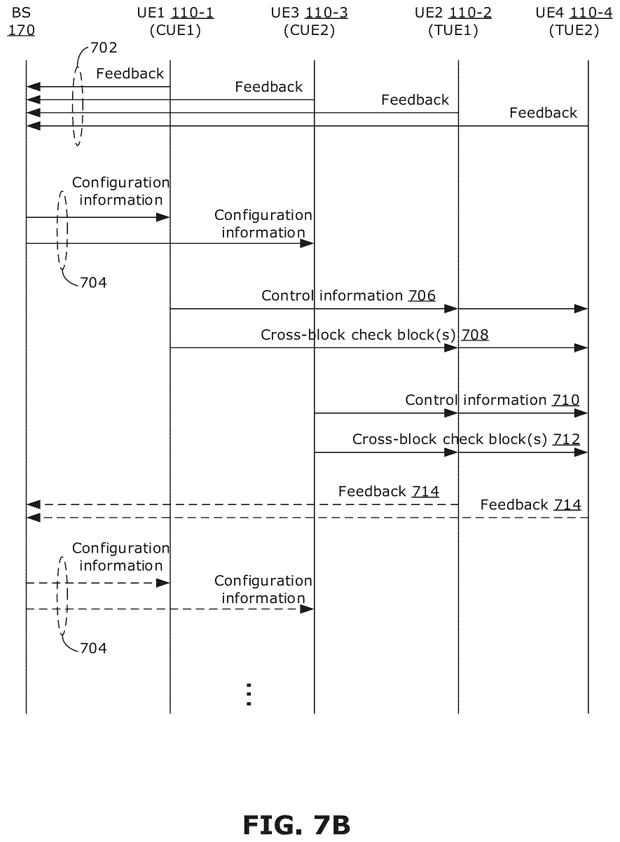

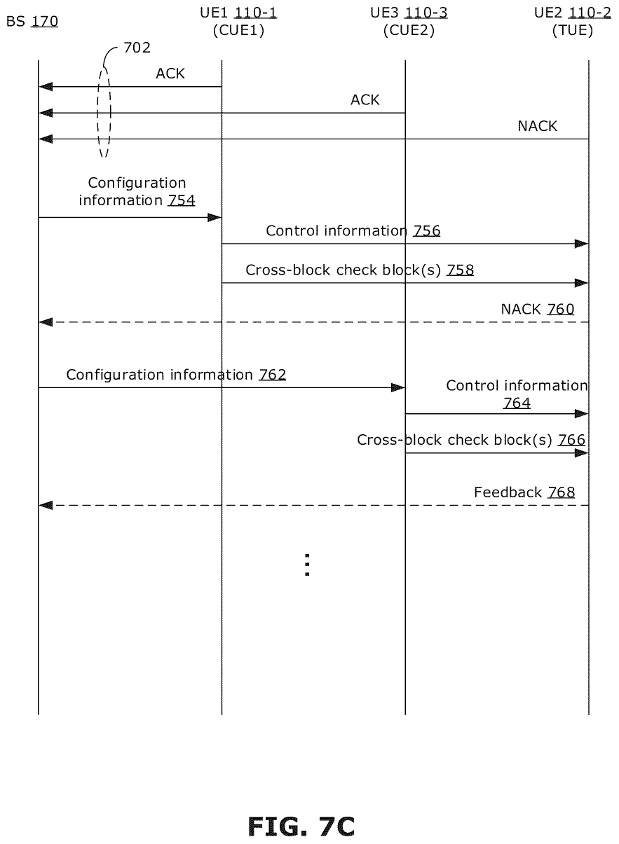

FIG. 7A is a signaling diagram illustrating an example of centralized cooperation. FIG. 7A illustrates a BS 170 as the centralized entity providing the control signaling, to configure two UEs (specifically UE1 110-1 and UE3 110-3 in this example) to act as CUEs to perform retransmissions to one TUE (specifically UE2 110-2 in this example). It should be understood that this is not intended to be limiting. For example, some other centralized entity (e.g., another network node) may provide the control signaling. Further, there may be different numbers of CUEs, and there may be more than one TUE. For simplicity, FIG. 7A does not show the initial groupcast, multicast or broadcast transmission (which may be transmitted by the same or different BS 170 that is the centralized entity providing the control signaling).

Each of UE1 110-1, UE2 110-2 and UE3 110-3 is a UE 110 that is an intended recipient of an initial multicast, groupcast or broadcast transmission (not shown). Each UE 110 in a group of intended recipients may be preconfigured with a unique UE index within the group. In this example, UE1 110-1 may have UE index 1; UE2 110-2 may have UE index 2; and UE1 110-3 may have UE index 3. The initial transmission includes a plurality of CBs from one or more packets. At 702, the BS 170 receives feedback 702 from one or more of the UEs 110 indicating successful and/or unsuccessful decoding of the initial transmission. The feedback 702 may be transmitted over any suitable uplink (UL) channel, for example. In some examples, the UEs 110 may only transmit feedback indicating a successful decoding (e.g., a positive acknowledgement (ACK)), may only transmit feedback indicating an unsuccessful decoding (e.g., a negative acknowledgement (NACK)), or may transmit feedback for both successful and unsuccessful decoding (e.g., both ACK and NACK). In this example, UE1 110-1 and UE3 110-3 successfully decoded the initial transmission and transmits ACK to the BS 170, however UE2 110-2 was unsuccessful in decoding the initial transmission and transmits NACK to the BS 170.

Based the received feedback 702, the BS 170 may determine one or more UEs that successfully decoded the initial transmission should act as a CUE to assist one or more other UEs that were unsuccessful in the decoding. In this example, the BS 170 determines that UE1 110-1 and UE3 110-3 should both act as CUEs (designated as CUE1 and CUE2, respectively) to assist UE2 110-2 (designed as TUE). The BS 170 transmits configuration information 704 (e.g., via a downlink (DL) configuration message) to each of UE1 110-1 and UE3 110-3 to configure the generation and retransmission of cross-block check blocks. In some examples, a UE that successfully decoded all CBs in the initial transmission may determine itself to be a CUE and may inform the BS 170 of its role as a CUE via the feedback 702 (which may include, for example, an ACK and a separate indicator of the CUE role). The BS 170 may also configure the order of retransmission among the CUEs (e.g., in accordance with the order of UE indexes).

The configuration information 704 may configure each of UE1 110-1 and UE3 110-3 to perform one or more retransmissions using the fractional retransmission scheme or using the full retransmission scheme, for example.

If a fractional retransmission scheme is used, the configuration information 704 may indicate the RV index (which is associated with the set of interleavers to use to generate the set of cross-block check blocks) and the cross-block check block index(es) for each CUE. The cross-block check block index(es) may indicate which of the cross-block check blocks each CUE should send in its respective retransmission. As mentioned above, in a fractional retransmission scheme each CUE performs a retransmission using a respective subset of the same set of generated cross-block check block(s) (e.g., based on the fraction N/K where N denotes the number of cross-block check blocks in the set associated with a given RV index used by all CUEs, and K denotes the number of CUEs). The BS 170 may control which CUE transmits which subset of cross-block check block(s) by transmitting different cross-block check block index(es) to each CUE. For example, assuming that there are four cross-block check blocks in the set that can be generated for RV index 1, the configuration information to UE1 110-1 may indicate RV index 1 and cross-block check block indexes 1, 2; and the configuration information to UE3 110-3 may indicate RV index 1 and cross-block check block indexes 3, 4. In this way, UE1 110-1 and UE3 110-3 each generates and transmits a different subset of the generated cross-block check blocks, such that UE2 110-2 receives the full set of cross-block check blocks.

In some examples, the configuration information may, instead of explicitly indicating the RV index and cross-block check block index(es) to each CUE, provide information that allows each CUE to determine its own RV index and cross-block check block index(es). For example, the number of cross-block check block(s) that is associated with a given RV index and the technique for determining the subset of cross-block check block(s) (e.g., how to determine the fraction N/K, and how to adapt if the fraction N/K is not an integer, as discussed above) may be predefined and known to each UE 110 (e.g., specified in a wireless communication standard). In such a scenario, the BS 170 may provide configuration information to each CUE indicating the RV index of a first CUE in the group of participating CUEs, the total number of participating CUEs and the order of each CUE among the group of CUEs (e.g., the order of each CUE may be indicated by a CUE index, which may or may not be the same as the UE index of each UE within the group). For example, the configuration information 704 to UE1 110-1 may indicate RV index 1, a total of two CUEs and that UE1 110-1 is the first CUE (designated as CUE1); and the configuration information 704 to UE3 110-3 may indicate RV index 1, a total of two CUEs and that UE3 110-3 is the second CUE (designated as CUE2). Each CUE may then use its order within the group of CUEs and the RV index of the first CUE to determine the RV index and cross-block check block index(es) applicable to itself.

If a full retransmission scheme is used, the configuration information 704 may only need to indicate the RV index (which is associated with the set of interleavers to use to generate the set of cross-block check blocks) for each CUE. The cross-block check block index need not be indicated because each CUE is configured to generate and retransmit the full set of generated cross-block check blocks. In some examples, the RV index may be indicated by only indicating the RV index of the first CUE in the group of participating CUEs, with each CUE determining its own RV index to use, as described above.

In some examples, each CUE may be capable of performing a fractional retransmission (i.e., transmitting only a subset of the set of cross-block check blocks associated with a given RV index) or a full retransmission (i.e., transmitting the entire set of cross-block check blocks associated with a given RV index). The BS 170 may explicitly indicate (e.g., using a binary flag) in the configuration information 704 whether fractional retransmission scheme or full retransmission scheme is to be used. In other examples, the presence of a cross-block check block index in the configuration information 704 may implicitly indicate that fractional retransmission is to be used, and the absence of any cross-block check block index in the configuration information 704 may implicitly indicate that full retransmission is to be used. In other examples, each CUE may be preconfigured (e.g., by a wireless communication technical standard) to use only fractional retransmission schemes or only full retransmission schemes.

In some examples, the configuration information may include other control information such as the resources and parameters to be used for sidelink or device-to-device transmission by each CUE.

Each CUE (i.e., each of UE1 110-1 and UE3 110-3 in this example), in response to receiving the configuration information 704, generates a set of cross-block check blocks in accordance with the configuration information 704. If a fractional retransmission scheme is being used, UE1 110-1 and UE3 110-3 may generate respective subsets of the same set of cross-block check blocks (using the same RV index). If a full retransmission scheme is being used, UE1 110-1 and UE3 110-3 may generate different sets of cross-block check blocks (using different RV indexes). As previously mentioned, the association between an indicated RV index and the set of interleavers to use for generating the set of cross-block check blocks may be predefined and known to each UE 110 (e.g., may be specified in a wireless communication standard and stored at the UE 110).

Prior to retransmission of one or more cross-block check blocks, each CUE (i.e., each of UE1 110-1 and UE3 110-3 in this example) may transmit control information (e.g., a sidelink control information (SCI) message) to each TUE (i.e., UE2 110-2 in this example), indicating the RV index and/or the cross-block check block index, as well as other control information. In this example, UE1 110-1 transmits control information 706 to UE2 110-2 followed by retransmission of one or more cross-block check block(s) 708 (which may be the full set of cross-block check blocks associated with the RV index indicated in the control information 706, or a subset of the cross-block check blocks associated with the indicated RV index). Similarly, UE3 110-3 transmits control information 710 to UE2 110-2 followed by retransmission of one or more cross-block check block(s) 712 (which may be the full set of cross-block check blocks associated with the RV index indicated in the control information 710, or a subset of the cross-block check blocks associated with the indicated RV index).

The resources used by each CUE for sidelink or device-to-device transmission to the TUE may be determined by the BS 170 and indicated in the configuration information 704 to each CUE. Each CUE may include the sidelink resource information in the configuration information to each TUE. If there are multiple TUEs (e.g., as shown in FIG. 7B, discussed further below), the BS 170 may allocate the same sidelink or device-to-device resource and RV index to all TUEs in a multicast or groupcast group, which may be more efficient for centralized cooperation. In other examples, the BS 170 may configure different CUE(s) to perform retransmission for different TUEs (although this approach may be less efficient since, typically, each TUE in the multicast or groupcast group may be expecting the same multicast data).

After receiving the cross-block check block(s) from one or more CUEs (i.e., UE1 110-1 and UE3 110-3 in this example), the TUE (i.e., UE2 110-2 in this example) combines the packets from the initial transmission and the cross-block check block(s) received from the retransmission(s) to jointly decode the data from the initial transmission. Optionally, the TUE may transmit feedback 714 to the BS 170 indicating successful decoding (e.g., ACK) or unsuccessful decoding (e.g., NACK). If the BS 170 receives ACK from all TUEs (or absence of NACK from each and every TUE), the BS 170 may determine that retransmission can end. The BS 170 may end retransmission by not configuring any CUE to perform another retransmission, or by sending a termination message to each CUE. In some examples, in the absence of feedback from the TUEs, a predefined maximum number of retransmissions may be performed. Optionally, the BS 170 may send configuration information 716 to each CUE for every retransmission, or the configuration information 704 first sent by the BS 170 may already configure the CUEs to perform a number of retransmissions.

The signaling shown in FIG. 7A may be repeated until the TUE has successfully decoded the CBs of the initial transmission, or until a predefined maximum number of retransmissions has been performed.

FIG. 7B is a signaling diagram illustrating another example of centralized cooperation. In this example, there is a plurality of TUEs that are assisted by CUEs. FIG. 7B is similar to FIG. 7A, but the addition of UE4 110-4 as another TUE. FIG. 7B does not show the initial groupcast, multicast or broadcast transmission (which may be transmitted by the same or different BS 170 that is the centralized entity providing the control signaling).

Both UE2 110-2 and UE4 110-4 did not successful decode all the CBs of the initial transmission, and thus are both TUEs (designated as TUE1 and TUE2, respectively) assisted by the retransmission of cross-block check block(s) by UE1 110-1 and UE3 110-3. It should be noted that the CBs that were unsuccessfully decoded by UE2 110-2 and UE4 110-4 may be different CBs. Because each cross-block check block generated and retransmitted by UE1 110-1 and UE3 110-3 is generated using bits sampled from across multiple CBs, each cross-block check block can provide information to assist decoding by UE2 110-2 and UE4 110-4, regardless of which specific CBs were not successfully decoded.

The signaling illustrated in FIG. 7B is similar to that of FIG. 7A and need not be described again in detail. However, it may be pointed out that the transmission of the control information 706 and retransmission of one or more cross-block check block(s) 708 by UE1 110-1 is a multicast, groupcast or broadcast, which is received by both UE2 110-2 and UE4 110-4. Similarly, transmission of the control information 710 and retransmission of one or more cross-block check block(s) 712 by UE3 110-3 is a multicast, groupcast or broadcast received by both UE2 110-2 and UE4 110-4. It may not be necessary to transmit to each TUE individually. Thus, the operation of the CUE may be unaffected by whether there is one TUE or multiple TUEs. As mentioned above, the BS 170 may allocate the same sidelink or device-to-device resource and RV index to all TUEs in a multicast or groupcast group, which may be more efficient for centralized cooperation.

In other examples, the BS 170 may configure different CUE(s) to perform retransmission for different TUEs. For example, the BS 170 may send configuration information 704 to UE1 110-1 to cause UE1 110-1 to transmit control information 706 and cross-block check block(s) 708 only to UE2 110-2; and the BS 170 may send configuration information 704 to UE3 110-3 to cause UE3 110-3 to transmit control information 710 and cross-block check block(s) 712 only to UE4 110-4.

Each TUE combines the cross-block check block(s) received in the retransmission and the packets from the initial transmission and again attempts to decode the data from the initial transmission. Optionally, each TUE may transmit feedback 714 to the BS 170 indicating successful decoding (e.g., ACK) or unsuccessful decoding (e.g., NACK). If the BS 170 receives ACK from all TUEs (or absence of NACK from each and every TUE), the BS 170 may determine that retransmission can end. If the BS 170 receives feedback 714 indicating that one of the TUE (e.g., UE2 110-2) was successful in decoding the initial transmission, but that another of the TUE (e.g., UE4 110-4) is still unsuccessful in decoding the initial transmission, the BS 170 may determine that another retransmission is required, but that UE2 110-2 is now available to serve as a CUE while UE4 110-4 remains as a TUE that requires assistance. Thus, the role of each UE 110 as a CUE or a TUE (or neither, if not configured as a CUE and also not a TUE requiring assistance) may change from one retransmission to the next.

The signaling illustrated in FIG. 7B may be performed for a predefined maximum number of transmissions, or until all TUEs have successfully decoded all CBs (e.g., the BS 170 receives ACK from both UE2 110-1 and UE4 110-4).

FIG. 7C is a signaling diagram illustrating another example of centralized cooperation, in a scenario where each CUE transmits the full set of generated cross-block check blocks (i.e., using a full retransmission scheme). FIG. 7C illustrates the BS 170, two CUEs (UE1 110-1 designated as CUE1 and UE3 110-3 designated as CUE3) and one TUE (UE2 110-2), similar to FIG. 7A. FIG. 7C does not show the initial groupcast, multicast or broadcast transmission (which may be transmitted by the same or different BS 170 that is the centralized entity providing the control signaling). Although FIG. 7C illustrates a single TUE, it should be understood that similar signaling may be performed in the case of multiple TUEs (e.g., each retransmission may be a multicast, groupcast or broadcast received by all TUEs).

Similar to FIG. 7A, the BS 170 receives feedback 702 from one or more of the UEs 110. Based the received feedback 702, the BS 170 determines that both UE1 110-1 and UE3 110-3 can operate as CUEs to assist UE2 110-2 (designed as TUE). In some examples, a UE that successfully decoded all CBs in the initial transmission may determine itself to be a CUE and may inform the BS 170 of candidacy as a CUE via the feedback 702 (which may include, for example, an ACK and a separate indicator of its candidacy for the CUE role). Unlike the example of FIG. 7A, the BS 170 transmits configuration information 754 (e.g., via a DL configuration message) to only one of the CUEs (in this example, UE1 110-1) to configure the generation and retransmission of cross-block check blocks. The result is that only one UE 110 is configured to serve as a CUE for one retransmission. For example, the BS 170 may determine the UE index of each UE 110 that successfully decoded the initial transmission (and thus can be a candidate to serve as a CUE) and select the UE 110 having the lowest UE index among those candidates as the CUE. Then each subsequent retransmission may be performed by the same initially selected CUE, or the BS 170 may select the next CUE to be the candidate having the next-lowest UE index, and so forth.

The configuration information 754 configures the selected CUE (i.e., UE1 110-1 in this example) to perform one or more retransmissions using the full retransmission scheme. For example, the configuration information 754 may indicate the RV index (which is associated with the set of interleavers to use to generate the set of cross-block check blocks) for the selected CUE. The configuration information 754 may also include other control information such as the resources and parameters to be used for sidelink or device-to-device transmission by the selected CUE.

UE1 110-1, in response to receiving the configuration information 754, generates a set of one or more cross-block check blocks in accordance with the configuration information 754. Prior to retransmission of the set of one or more generated cross-block check blocks, UE1 110-1 may transmit control information (e.g., a SCI message) to each TUE (i.e., UE2 110-2 in this example), indicating the RV index, as well as other control information. In this example, UE1 110-1 transmits control information 756 to UE2 110-2 followed by retransmission of the set of one or more cross-block check block(s) 758.

After receiving the cross-block check block(s) from UE1 110-1, the UE2 110-2 combines the packets from the initial transmission and the cross-block check block(s) received from the retransmission to jointly decode the data from the initial transmission. In this example, UE2 110-2 is still not successful in decoding all the CBs of the initial transmission and optionally transmits NACK 760 to the BS 170. When the BS 170 receives the NACK 760 from UE2 110-2 (or in the absence of an ACK from UE2 110-2), the BS 170 determines that another retransmission is required.

The BS 170 selects the same or different UE 110, from among the candidates for CUE (i.e., those UEs 110 that have successfully decoded the initial transmission), to serve as the CUE for the next transmission. In this example, the BS 170 selects the next CUE according to the order of UE indexes (e.g., select the next-lowest UE index from among the CUE candidates), which is UE3 110-3. The BS 170 transmits configuration information 762 in a DL configuration message to UE3 110-3. The configuration information 762 indicates the RV index to be used by UE3 110-3 for the retransmission. It should be noted that the RV index configured for the first retransmission by UE1 110-1 and the RV index configured for the second retransmission by UE3 110-3 may be different, to avoid redundancy.

UE3 110-3 generates a set of one or more cross-block check blocks in accordance with the configuration information 762 (e.g., using the set of interleavers associated with the indicated RV index). UE3 110-3 may transmit control information 764 to UE2 110-2 and perform a retransmission of the full set of generated cross-block check block(s) 766, similar to the retransmission performed by UE1 110-1. UE2 110-2 uses the cross-block check block(s) 766 from this retransmission, in addition to the cross-block check block(s) 758 from the prior retransmission, to assist in another decoding operation to decode the initial transmission. Optionally, UE2 110-2 may transmit feedback 768 (e.g., ACK or NACK, depending on success of the decoding) to the BS 170.

The retransmissions may be repeated until UE2 110-2 has successfully decoded the CBs of the initial transmission, or until a predefined maximum number of retransmissions has been performed.

Examples of distributed cooperation are now described. Compared with centralized cooperation (e.g., as illustrated in FIGS. 7A-7C), distributed cooperation does not involve a centralized entity to control how each CUE performs retransmission. Instead of relying on a centralized network entity (e.g., a BS 170) to configure the CUEs, in distributed cooperation each UE 110 self-determines its role (as a CUE, as a TUE or neither) and each UE 110 that is a CUE self-determines how to generate and transmit the cross-block check block(s) in a retransmission.

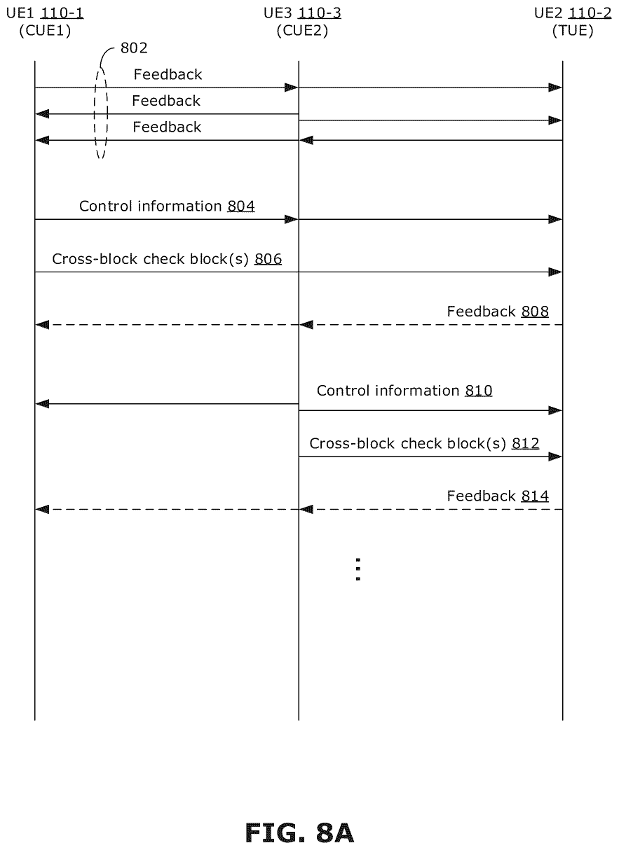

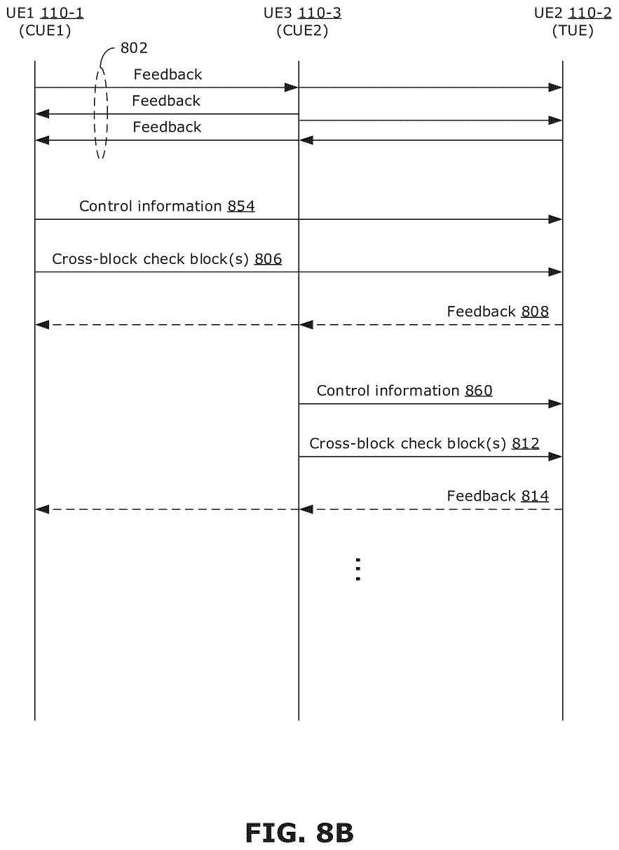

FIG. 8A is a signaling diagram illustrating an example of distributed cooperation. For simplicity, FIG. 8A does not show the initial groupcast, multicast or broadcast transmission (which may be transmitted by a BS 170, not shown).

Each of UE1 110-1, UE2 110-2 and UE3 110-3 is a UE 110 that is an intended recipient of an initial multicast, groupcast or broadcast transmission (not shown). Each UE 110 in a group of intended recipients may be preconfigured with a unique UE index within the group. In this example, UE1 110-1 may have UE index 1; UE2 110-2 may have UE index 2; and UE1 110-3 may have UE index 3. The SL resource (e.g., SL feedback channel) for each UE 110 may also be preconfigured before the initial transmission and may be specifically mapped to the UE index of each UE 110. The SL feedback channel may be defined the group of UEs 110 is first defined for the initial groupcast, broadcast or multicast transmission. For example, defining the group of UEs 110 and preconfiguring the UEs 110 in the group of intended recipients may be performed by a network node (e.g., a BS 170). The feedback channel may be the same as the physical sidelink feedback channel (PSFCH) used for groupcast in SL transmission.

Similar to FIG. 7A, in FIG. 8A the initial transmission to the UEs 110 includes a plurality of CBs from one or more packets. At 802, the UEs 110 provide feedback to each other (e.g., over a SL feedback channel), for example using broadcast transmissions, indicating successful and/or unsuccessful decoding of the initial transmission. Similar to the example of FIG. 7A, the UEs 110 may only transmit feedback indicating a successful decoding (e.g., a positive acknowledgement (ACK)), may only transmit feedback indicating an unsuccessful decoding (e.g., a negative acknowledgement (NACK)), or may transmit feedback for both successful and unsuccessful decoding (e.g., both ACK and NACK). In this example, UE1 110-1 and UE3 110-3 successfully decoded the initial transmission (and their feedback may be ACKs), however UE2 110-2 was unsuccessful in decoding the initial transmission (and its feedback may be a NACK).

Each UE 110 that successfully decoded the initial transmission may self-determined its role as CUE. After receiving the feedback 802 from other UEs 110, each CUE determines its own turn to perform a retransmission. Each CUE may determine, based on an ordered list of UE indexes, its own order to perform a retransmission. For example, the CUE having the lowest UE index may perform the first retransmission, then the CUE having the next-lowest UE index may perform the second retransmission, and so forth. How cross-block check block(s) are to be generated (e.g., using which RV index) and how the generated cross-block check block(s) are retransmitted (e.g., using fractional retransmission (and if so, how to determine the subset of cross-block check block(s) such as how to determine the fraction N/K or how to determine the subset when the fraction N/K is not an integer) or full retransmission) may be preconfigured at each UE 110 (e.g., specified in a wireless communication standard). For example, the UEs 110 may be preconfigured to start performing retransmissions using RV index 1, and if preconfigured to use fractional retransmission the UEs 110 may be preconfigured to start with cross-block check block index 1. Then the following retransmission continues at the next RV index and/or next cross-block check block index that follows the last cross-block check block of the preceding retransmission. If fractional retransmission is being used, the technique for determining the subset of cross-block check blocks (e.g., how to determine the number of cross-block check blocks in the subset (for example, how to determine the fraction N/K and how to determine the number of cross-block check blocks in the subset in the case where N/K is not an integer) may also be preconfigured.

In this example, UE1 110-1 determines it has the lowest UE index among possible CUEs. UE1 110-1 transmits control information 804 (e.g., a SL control message) over a multicast, groupcast or broadcast to all the UEs 110 in the group (i.e., to both UE2 110-2 and UE3 110-3 in this example). The control information 804 indicates the RV index and/or the cross-block check block index, as well as other control information. The control information 804 is not only used by the TUE (i.e., UE2 110-2 in this example) to enable the TUE to make use of the cross-block check block(s) in the retransmission, but may also be used by other CUEs (i.e., UE3 110-3 in this example) to enable other CUEs to determine its own turn to perform a retransmission and/or to determine which RV index and/or which cross-block check block index to use for the retransmission. The control information 804 is followed by a multicast, groupcast or broadcast of one or more cross-block check blocks 806 (which may be the full set of cross-block check blocks associated with the RV index indicated in the control information 804, or a subset of the cross-block check blocks associated with the indicated RV index).

UE2 110-2 combines the cross-block check block(s) 806 from UE1 110-1 with the CBs of the initial transmission and performs a decoding operation to attempt to decode the initial transmission. Optionally, UE2 110-2 broadcasts feedback 808 indicating its success or failure to decode the initial transmission. In this example, UE2 110-2 still was not able to successfully decode all the CBs of the initial transmission, and a NACK may be transmitted.

In response to the NACK from UE2 110-2 (or in response to absence of an ACK), the CUE with the next-lowest UE index (i.e., UE3 110-3 in this example) determines its turn to perform a transmission. UE3 110-3 determines, from the control information 804 received from UE1 110-1, that UE1 110-1 has performed a retransmission and that UE3 110-3 itself is next in order to perform a retransmission. UE3 110-3 uses the control information 804 from UE1 110-1 to determine the RV index and/or cross-block check block index to use for the next retransmission. For example, if a fractional retransmission scheme is used, the control information 804 may indicate that the first retransmission from UE1 110-1 used RV index 1 and cross-block check block indexes 1, 2 (assuming there are four cross-block check blocks in the set of cross-block check blocks associated with RV index 1). Then UE3 110-3 may determine that its retransmission should be performed using RV index 1 and cross-block check block indexes 3, 4 (thus completing transmission of the set of cross-block check blocks associated with RV index 1). If a full retransmission scheme is used, the control information 804 may indicate that the first retransmission from UE1 110-1 used RV index 1 (it may not be necessary to indicate any cross-block check block index). Then UE3 110-3 may determine that its own retransmission should be performed using RV index 2.

UE3 110-3 may send control information 810 and one or more cross-block check blocks 812 (e.g., over multicast, groupcast or broadcast). UE2 110-2 uses the information received in this second retransmission, together with information from the first retransmission and the initial transmission, to perform another decoding operation to decode the initial transmission. Optionally, UE2 110-2 transmits feedback 814 indicating successful or unsuccessful decoding. The signaling may continue for a predefined maximum number of retransmissions or until all TUEs have successfully decoded the initial transmission.

Although FIG. 8A illustrates a single TUE, similar signaling may be performed if there are multiple TUEs, since each CUE broadcasts (or multicasts or groupcasts) its control information and cross-block check block(s) to all UEs 110 in the group. The signaling may be similar for both fractional retransmission and full retransmission. In some examples, if fractional retransmission is used, each TUE may transmit feedback only after all cross-block check blocks in the set of cross-block check blocks associated with a given RV index have been sent (e.g., if UE1 110-1 transmits half the cross-block check blocks for RV index 1 and UE3 110-3 transmits the remaining half of cross-block check blocks for RV index 1, UE2 110-2 may transmit feedback only after the retransmission performed by UE3 110-3).

In some examples, prior to the initial transmission (e.g., when the group of UEs 110 is first defined), each UE 110 may be assigned (e.g., by a BS 170) a respective timeslot for SL transmission/reception. Then, during retransmission, each UE 110 serving as a CUE will use its assigned timeslot for transmitting cross-block check block(s), so that each CUE will transmit at a different timing.

An issue that may arise is that a UE 110 may have error in decoding the ACK/NACK feedback from other UEs 110 (e.g., in the feedback phase 802 after the initial retransmission), with the result that there can be errors in identifying another UE 110 as a CUE or TUE. For example, UE1 110-1 (which has determined itself to be a CUE) may erroneously decode the ACK (at 802) from UE3 110-3 as NACK and UE1 110-1 may erroneously consider UE3 110-3 to be a TUE (and thus not included in the CUEs for determining CUE retransmission order), or UE1 110-1 may erroneously decode the NACK (at 802) from UE2 110-2 as ACK and UE1 110-1 may erroneously consider UE2 110-2 to be a CUE (and thus added to the CUEs for determining CUE retransmission order). In both cases, the result may be that UE1 110-1 erroneously determines its own order of retransmission among the CUEs. This can result in UE1 110-1 erroneously performing a retransmission at the same time as another CUE (thus causing undesirable interference). This issue may be overcome by the use of preassigned timeslots for each UE 110, as described above, so that UE1 110-1 will perform a retransmission in its own uniquely assigned timeslot (thus not overlapping in time with any other retransmission), thus not causing interference.

In some examples, the issue of erroneous decoding of ACK/NACK may additionally or alternatively be addressed by using only NACK feedback without ACK feedback. This means that feedback from a UE 110 indicates that the UE 110 did not successfully decode the initial transmission (and thus may be a TUE), while the absence of any feedback from a UE 110 indicates that the UE 110 was successful in decoding the initial transmission (and thus may serve as a CUE).

In some examples, instead of retransmissions being performed sequentially in time (e.g., CUEs perform transmissions according to the order of UE indexes), CUEs may alternatively perform retransmissions in parallel (i.e., simultaneously or overlapping in time) via the use of orthogonal frequency resources (while using the same time resources). The orthogonal frequency resources may be preconfigured for each UE 110 in the group prior to the initial transmission.

As mentioned above, if a fractional retransmission scheme is used, the cross-block check block(s) sent in a retransmission by a CUE may be a subset of the set of cross-block check blocks associated with a given RV index (e.g., if four cross-block check blocks are associated with RV index 1, only two cross-block check blocks may be sent in a retransmission by a given CUE). On the other hand, if a full retransmission scheme is used, the full set of cross-block check blocks associated with a given RV index is sent in a retransmission by a CUE. This means that, compared to the fractional retransmission scheme, using a full retransmission scheme may reduce the signaling overhead because the CUE does not need to include the cross-block check block indexes in its SL control information.

In distributed cooperation, there is no centralized entity, hence each CUE is responsible for decoding the SL control information transmitted (e.g., in a multicast, groupcast or broadcast) from every other CUE prior to a retransmission, in order for each CUE to determine the RV index (and, in the case of fractional retransmission, also the cross-block check block index) to use for its own retransmission.

In some examples, when full retransmission is used, the need for each CUE to decode the SL control information from other CUEs may be avoided, to reduce the complexity (and the processing power required) and to increase efficiency. As mentioned above, in a full retransmission scheme each CUE does not need to know the cross-block check block indexes transmitted by another CUE. In some examples, instead of a given CUE having to decode the SL control information from another CUE in order to determine the RV index used by the other CUE (and thus the next RV index that should be used by the given CUE), each given CUE may select the RV index to use for its own retransmission, without consideration of the RV index used by another CUE in another retransmission.

For example, each CUE may randomly select the RV index to use for its own retransmission, regardless of which RV index is selected by other CUEs. In such a random selection approach, the UE index of each CUE is not required to determine the RV index (although the UE index of the CUEs may still be used to determine the order of CUEs for performing retransmissions sequentially in time). Because the RV index is randomly selected at each CUE, there is a possibility that two or more CUEs may select the same RV index (and thus transmit the same set of cross-block check blocks in a retransmission). However, the chance of one CUE randomly selecting the same RV index as another CUE may be relatively low and may provide improved efficiency of not needing to decode the SL control information.

FIG. 8B is a signaling diagram illustrating an example of distributed cooperation using a full retransmission scheme, in which each CUE self-selects the RV index to use without needing to decode the control information from another CUE.

FIG. 8B is similar to FIG. 8A, where UE1 110-1 and UE3 110-3 serve as CUEs to assist UE2 110-2 as the TUE. However, in FIG. 8B the control information 854 that is transmitted by UE1 110-1 only needs to be received and decoded by UE2 110-2 and not UE3 110-3. Similarly, the control information 860 that is transmitted by UE3 110-3 only needs to be received and decoded by UE2 110-2 and not UE1 110-1. Further, the set of cross-block check block(s) 806 transmitted by UE 110-1 may be generated using a self-selected RV index (e.g., randomly selected), which may not be RV index 1. Similarly, the set of cross-block check block(s) 812 transmitted by UE3 110-3 may be generated using a self-selected RV index (e.g., randomly selected), which may not be sequentially following the RV index used by UE1 110-1.

It should be understood that self-selection of the RV index by a CUE may be performed using any RV index selection technique, not necessarily limited to random selection. For example, the RV index may be selected using a pseudo-random function or using a formula. In some examples, the RV index may be selected based on the UE index of the CUE, and some example RV index selection techniques are described below.

For example, for a CUE having UE index i, the RV index (denoted as RVᵢ) may be self-selected using the following formula:

$$R {V}_{i} = \{ \begin{matrix}i mod {N}_{RV} , & if i mod {N}_{RV} \neq 0 \\ {N}_{RV} , & otherwise\end{matrix}$$

where N_{RV} denotes the number of RV indexes available (e.g., the number of different RV indexes that are associated with predefined interleavers in a wireless communication technical standard) and the set of available RV indexes is given by {1, . . . , N_{RV}} (in this example RV index 0 is reserved for the initial transmission). mod refers to the modulo operation.

Using a formula-based approach to self-select the RV index based on the UE index means that each UE 110, when serving as a CUE, will always use the same RV index for its retransmission. Since the UE index is preconfigured prior to the initial transmission and the set of available RV indexes is also preconfigured, the RV index that is used by each UE 110 may also be determined in advance.

A drawback of the RV selection technique described above is that the same RV index may be selected by multiple CUEs. For example, if UEs 110 with UE indexes {1, 5, 9} are serving as CUEs and there are four RV indexes available, then RV₁=1 mod(4)=1; RV₅=5 mod(4)=1; and RV₉=9 mod(4)=1. In other words, all three CUEs will self-select the same RV index 1 for performing their retransmission. An approach to help address this drawback is to map the UE index i of each CUE to its order (denoted nᵢ) in the group of CUEs, where nᵢ∈{1, . . . , K} with K being the number of CUEs. Then, the RV index RVᵢ of CUE i may be self-selected using the following formula:

$$R {V}_{i} = \{ \begin{matrix}{n}_{i} mod {N}_{RV} , & if {n}_{i} mod {N}_{RV} \neq 0 \\ {N}_{RV} , & otherwise\end{matrix} ,$$

Consider the example described above, where there are three CUEs with the UE indexes {1, 5, 9}. When the CUEs are ordered in order of increasing UE index, the CUEs are mapped to the CUE order numbers {1, 2, 3}. Then the three CUEs will end up self-selecting RV index 1, RV index 2 and RV index 3, respectively.

It should be appreciated that, using the above formula, it can be guaranteed that each CUE selects a different RV index for performing a retransmission as long as the number of CUEs is equal to or less than the number of available RV indexes. It may also be noted that, because the RV index used by a given CUE is determined based on the order of the given CUE within the group of CUEs, the RV index that is used by a given CUE may change from one retransmission to the next.

By enabling a CUE to self-select the RV index when using a full retransmission scheme with distributed cooperation, the need for a CUE to decode the SL control information from another CUE may be avoided (thus decreasing complexity and increasing efficiency in the overall retransmission scheme).

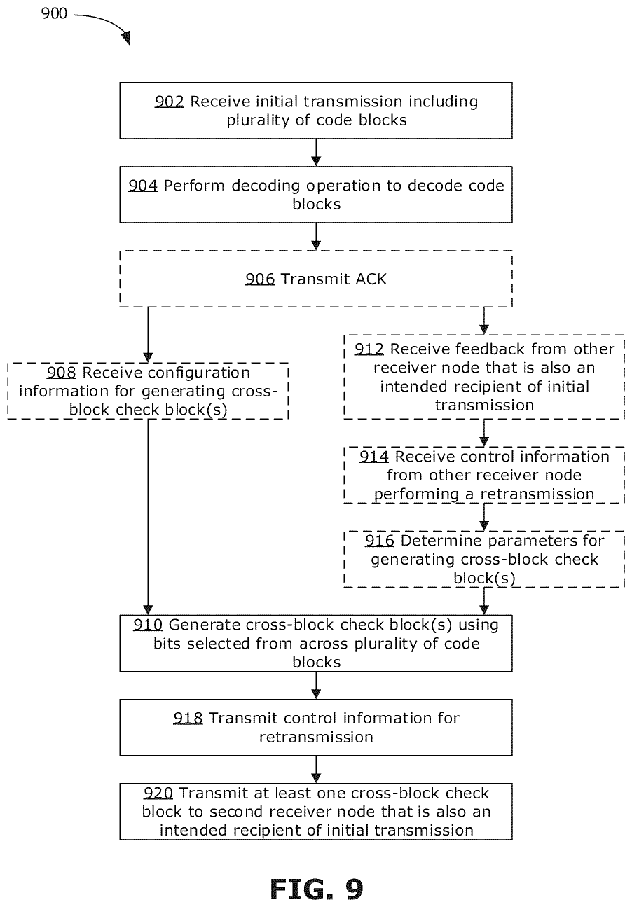

FIG. 9 is a flowchart illustrating an example method 900, which may be performed by an apparatus (e.g., as illustrated in FIG. 2) that is a first receiver node (e.g., a UE 110) serving as a CUE, to enable UE cooperation in a retransmission scheme using cross-block check blocks. The method 900 may be performed by the CUE in accordance with the signaling diagrams of FIGS. 7A-7C and 8A-8B, for example.

At 902, an initial transmission is received including a plurality of code blocks. The initial transmission may, for example, be a broadcast, groupcast or multicast to a group of intended recipients including the first receiver node performing the method 900. At some time prior to the initial transmission, the first receiver node is preconfigured (e.g., by a network node, such as a BS 170 or other transmitter node that may or may not be the same as the source of the initial transmission) with a UE index. The UE index is unique to the first receiver node within the group of intended recipients and represents the order of the first receiver node within the group of intended recipients. The initial transmission may be received from a transmitted node, such as a BS 170 (e.g., a non-terrestrial BS 170b or terrestrial BS 170).

At 904, the first receiver node performs a decoding operation (also referred to as a decoding attempt) to decode the plurality of code blocks. In the method 900, it is assumed that the first receiver node is successful in decoding all of the code blocks from the initial transmission.

Optionally, at 906, the first receiver node transmits feedback (e.g., ACK) indicating the initial transmission has been successfully decoded. In some examples, the first receiver node may not send any feedback and the absence of feedback may indicate a successful decoding of the initial transmission.

In the case where centralized cooperation is used, the feedback may be transmitted to a centralized entity (e.g., a central transmitter node, such as a BS 170, which may or may not be the same as the BS 170 that sent the initial transmission). The centralized entity may assign the first receiver node to serve as a CUE in response to receiving the ACK. In some examples, the first receiver node may self-determine to serve as a CUE and the ACK to the centralized entity may be send with a message indicating that the first receiver node has assigned itself to serve as a CUE.

In the case where distributed cooperation is used, the feedback may be transmitted to other receiver nodes in the group of intended recipients.

The method 900 may proceed to step 908 if centralized cooperation is used, or to step 912 if distributed cooperation is used.

Optionally, at 908, if centralized cooperation is used, the first receiver node may receive configuration information from the centralized entity (e.g., a central transmitter node). The configuration information indicates one or more parameters (e.g., RV index, cross-block check block index, etc.) for generating a set of one or more cross-block check blocks. The configuration information may also indicate the order of the first receiver node among a group of receiver nodes performing retransmissions. As described above, the configuration information may be provided in a variety of ways, and may depend on whether fractional retransmission (in which case the cross-block check block index(es) indicating the subset of cross-block check block(s) to send in a retransmission may be included in the configuration information) or full retransmission (in which case only the RV index may be included in the configuration information) is being used.

Alternatively, at 912, if distributed cooperation is used, the first receiver node may optionally receive feedback (e.g., ACK or NACK) from one or more other receiver nodes that are in the group of intended recipients of the initial transmission. As previously mentioned, each receiver node in the group may broadcast ACK or NACK to indicate successful or unsuccessful decoding, or may only broadcast NACK to indicate unsuccessful decoding (with the absence of any feedback indicating successful decoding).

If a NACK is received from a second receiver node, this may indicate that the second receiver node should be a TUE that is a target of the retransmission performed by the first receiver node. If an ACK is received or if there is absence of any feedback from a third receiver node, this may indicate that the third receiver node should be another CUE that will also perform a retransmission to the TUE.

If the first receiver node determines that there is at least one other CUE, the first receiver node may determine the order of CUEs to perform retransmissions, based on the order of the UE indexes of the CUEs as described above.

Optionally, at 914, the first receiver node may receive a control message from the third receiver node, indicating the retransmission performed by the third receiver node. This may be the case where, for example, the third receiver node is ahead of the first receiver node in the order of the UE indexes. The control message may indicate one or more parameters of the retransmission, such as the RV index and/or the cross-block check block indexes (e.g., depending on whether fractional retransmission or full retransmission is being used). If a fractional retransmissions scheme is used, the first receiver node may be preconfigured to determine the subset of cross-block check blocks to use in a retransmission (e.g., in accordance with a predefined technique to calculate the fraction of cross-block check blocks per CUE, as described above). The first receiver node may use the information in the control message to determine the RV index and/or cross-block check block indexes to use in its own retransmission. As mentioned above, in some examples if a full retransmission scheme is used the first receiver node may not need to decode the control message from the third receiver node and may instead self-select the RV index to use.

Optionally, at 916, the first receiver node may self-determine the parameters it should use for generating and transmitting cross-block check block(s) for its own retransmission. For example, if a fractional retransmission scheme is used, the first receiver node may, from the control message received at step 914, determine the RV index and cross-block check block index(es) retransmitted by the third receiver node, and further determine the RV index and cross-block check block index(es) to use itself, so that the subset of cross-block check block(s) retransmitted by the first receiver node is different from the subset of cross-block check block(s) retransmitted by the third receiver node (e.g., if the third receiver node transmits a subset of the set of cross-block check blocks associated with a given RV index, the first receiver node may transmit the remaining subset of the same set of cross-block check blocks).

In another example, if a full retransmission scheme is used, the first receiver node may, from the control message received at step 914, determine the RV index used by the third receiver node, and further determine the next RV index to use in its own retransmission, so that the set of cross-block check block(s) retransmitted by the first receiver node is different from the set of cross-block check block(s) retransmitted by the third receiver node.

In another example, if a full retransmission scheme is used and a self-selection technique is used by the first receiver node to select the RV index for performing a retransmission, the first receiver node may not need to receive or decode any control message from the third receiver node. Instead, the first receiver node may self-select the RV index (e.g., based on random selection, or making a selection based on the first receiver node's own UE index, among other possibilities) to use for its retransmission.

Regardless of whether centralized cooperation is used (e.g., using step 908) or distributed cooperation is used (e.g., using steps 912, 914 and/or 916), at 910 the first receiver node generates one or more cross-block check blocks using bits selected from across the plurality of code blocks (that were successfully decoded from the initial transmission).

The cross-block check block(s) may be generated in accordance with the configuration information received from the central transmitter node (in the case of centralized cooperation) or in accordance with the self-determined parameters (in the case of distributed cooperation).

For example, the first receiver node may use the RV index to determine the set of interleavers to use, and generate the set of cross-block check block(s) after applying the interleavers. In the case where fractional retransmission is used, the first receiver node may also use the cross-block check block index(es) to determine which particular cross-block check block(s) to generate. Alternatively, if fractional retransmission is used, the first receiver node may general the full set of cross-block check blocks associated with the RV index, and discard the cross-block check block(s) that are not indicated by the cross-block check block index(es).

The first receiver node may then perform a retransmission according to its order among the group of intended recipients. Alternatively, if orthogonal frequency resources have been preconfigured for each receiver node in the group, the first receiver node may use its assigned frequency resources to perform a retransmission without having to wait for its turn. In some examples, each preconfigured UE index may be associated with a preassigned timeslot for performing a retransmission. The first receiver node may thus perform a retransmission at the assigned timeslot associated with its UE index.

At 918, the first receiver node transmits control information (e.g., using a multicast, broadcast or groupcast control message) to at least the second receiver node (i.e., the TUE) prior to transmitting at least one cross-block check block. In the case of distributed cooperation, the transmitted control information may be used by other receiver nodes (i.e., other CUEs) to determine their respective retransmission parameters. If a fractional retransmission scheme is used, the control information may indicate the RV index as well as the cross-block check block index(es) (indicating the subset of cross-block check block(s) being sent in the retransmission). If a full retransmission scheme is used, the control information may only indicate the RV index.

At 920, at least one cross-block check block is transmitted in a retransmission to the second receiver node (i.e., the TUE). For example, the retransmission may be sent over a SL channel. If a full retransmission scheme is used, the full set of cross-block check block(s) generated at step 916 is transmitted to the second receiver node. If a fractional retransmission scheme is used, only a subset of the cross-block check block(s) generated at step 916 is transmitted to the second receiver node (where the subset may be based on a fraction of the number of cross-block check blocks associated with the RV index, divided by the number of CUEs).

The method 900 may return to step 908 (if using centralized cooperation) or step 912 (if using distributed cooperation) to repeat the retransmission. For example, retransmissions may be performed until a predefined maximum number of retransmissions is reached, or until all TUEs have successfully decoded the initial transmission.

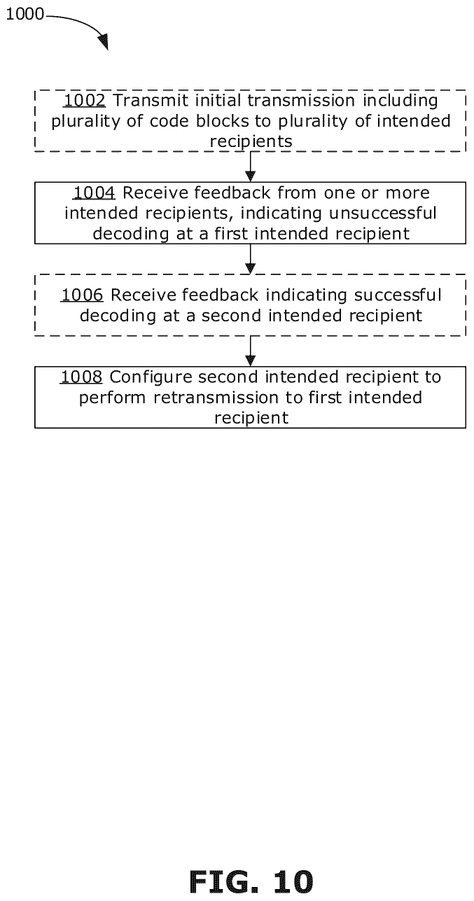

FIG. 10 is a flowchart illustrating an example method 1000, which may be performed by an apparatus (e.g., as illustrated in FIG. 2) that is a transmitter node (e.g., a BS 170) that acts as a centralized entity to enable centralized cooperation of UEs in a retransmission scheme using cross-block check blocks. The method 1000 may be performed by the BS 170 (or other network node) in accordance with the signaling diagrams of FIGS. 7A-7C, for example.

Optionally, at 1002, the transmitter node transmits an initial transmission (e.g., via broadcast, groupcast or multicast) including a plurality of code blocks to a plurality of intended recipients. Step 1002 may be performed if the transmitter node is the source of the initial transmission as well as the centralized entity controlling the CUEs for centralized cooperation. In other examples, the source of the initial transmission and the centralized entity providing centralized control may be different transmitter nodes (e.g., a non-terrestrial BS 170b may provide the initial transmission, and a different terrestrial BS 170 may provide centralized control), and step 1002 may be omitted.

At 1004, the transmitter node receives feedback from one or more of the intended recipients. The feedback indicates that a first one of the intended recipients was unsuccessful at decoding the initial transmission. For example, a NACK may be received from the first intended recipient, or the absence of ACK feedback from the first intended recipient may indicate unsuccessful decoding.

Optionally, at 1006, the transmitter node may receive feedback indicating that decoding was successful by at least a second intended recipient. A successful decoding may be indicated by the absence of NACK feedback, or by ACK feedback from the second intended recipient. In some cases, ACK feedback from the second intended recipient may include indication that the second intended recipient has self-selected to serve as a CUE to perform a retransmission.

At 1008, the transmitter node configures at least the second intended recipient to perform a retransmission to the first intended recipient. For example, the transmitter node may transmit configuration information to configure the second intended recipient with one or more parameters (e.g., RV index, cross-block check block index, etc.) for generating and transmitting the cross-block check block(s) in a retransmission. The parameter(s) indicated in the configuration information may depend on whether a fractional retransmission scheme or a full retransmission scheme is used, as described above.

For example, if a fractional retransmission scheme is used, the RV index may be indicated as well as the cross-block check block index(es), such that the second intended recipient is configured to perform a retransmission using a subset of the cross-block check block(s) associated with the RV index (with the remaining subset being retransmitted by one or more other CUEs).

If a full retransmission scheme is used, only the RV index may be indicated, and the second intended recipient may be configured to perform a retransmission using the full set of cross-block check block(s) associated with that RV index.

In some examples, the configuration information may also configure the order in which the second intended recipient is to perform retransmission, among multiple CUEs (e.g., by configuring a CUE index of the second intended recipient).

The method 1000 may return to step 1004 for one or more additional retransmissions. For example, retransmissions may be performed until a predefined maximum number of retransmissions is reached, or until all TUEs have successfully decoded the initial transmission.

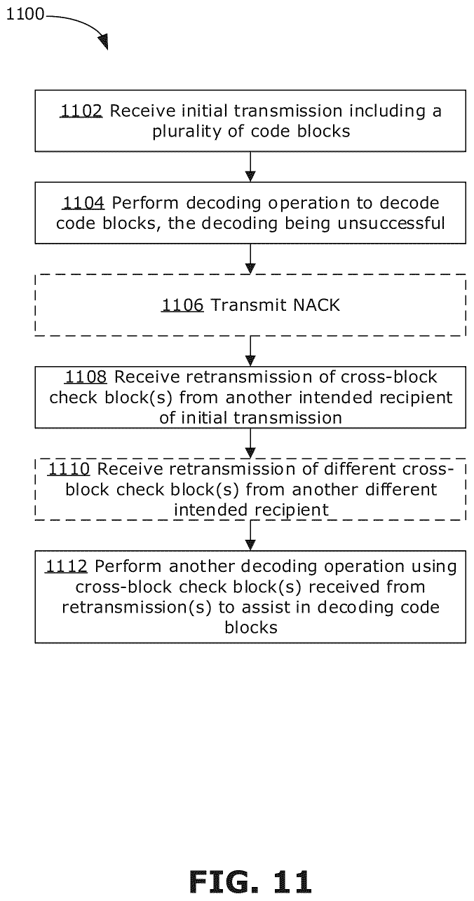

FIG. 11 is a flowchart illustrating an example method 1100, which may be performed by an apparatus (e.g., as illustrated in FIG. 2) that is a first receiver node (e.g., a UE 110) in the role of a TUE that is assisted by a UE-cooperative retransmission scheme. The method 1100 may be performed by the TUE in accordance with the signaling diagrams of FIGS. 7A-7C and 8A-8B, for example.

At 1102, the first receiver node receives an initial transmission (e.g., from a transmitter node such as a BS 170) including a plurality of code blocks. The initial transmission is a multicast, groupcast or broadcast transmission to a plurality of intended recipients including the first receiver node.

At 1104, the first receiver node performs a decoding operation (also referred to as a decoding attempt) to decode the code blocks. The decoding is unsuccessful (i.e., at least one of the code blocks was not correctly decoded).

Optionally, at 1106, the first receiver node transmits feedback (e.g., NACK) indicating it was unsuccessful at decoding the initial transmission. If centralized cooperation is used, the feedback may be transmitted to a centralized entity (which may be the same transmitter node as the source of the initial transmission, or may be a different transmitter node) in an uplink message. If distributed cooperation is used, the feedback may be multicast, groupcast or broadcast to other intended recipients (e.g., over a sidelink feedback channel).

In some examples, the first receiver node may not transmit feedback and the absence of feedback indicates that decoding was unsuccessful by the first receiver node.

At 1108, a retransmission is received from a second receiver node that is one of the intended recipients of the initial transmission. The retransmission includes at least one cross-block check block generated by the second receiver node.

Optionally, at 1110, another retransmission may be received from a different third receiver node that is another one of the intended recipients of the initial transmission. The other retransmission includes at least one different cross-block check block from the prior retransmission.

If a full retransmission scheme is used, the retransmission received at 1108 may be a first full set of cross-block check blocks generated by the second receiver node using a first RV index, and the retransmission received at 1110 may be a different second full set of cross-block check blocks generated by the third receiver node using a second RV index.

If a fractional retransmission scheme is used, the retransmission received at 1108 may be a subset of the cross-block check blocks associated with a given RV index, and the retransmission received at 1110 may be a remaining subset of the cross-block check blocks associated with the same given RV index.

It should be noted that the first receiver node may receive retransmissions from any number of CUEs. Each retransmission may be preceded by transmission of a control message providing information (e.g., RV index, cross-block check block index, etc.) to enable the first receiver node to make use of the information in the cross-block check blocks.

At 1112, the first receiver node performs another decoding operation, using the cross-block check block(s) received from all retransmissions to assist in decoding the code blocks of the initial transmission.

If decoding is still unsuccessful, the method 1100 may return to step 1106. The retransmissions may be repeated until a predefined maximum number of retransmissions has been performed, or until the first receiver now has successfully decoded the initial transmission.

Optionally, if decoding is successful, the first receiver node may transmit feedback (e.g., to the centralized entity in the case of centralized cooperation, or to other receiver nodes in the case of distributed cooperation) indicating successful decoding. If there is still another receiver node among the intended recipients that was not successful at decoding the initial transmission, the first receiver node may now serve as a CUE to assist the other receiver node (e.g., using the method 900).

In various examples, the present disclosure has described methods and apparatuses to enable UE cooperation in a retransmission scheme using cross-block check blocks. Examples have been described in which a retransmission by a CUE is performed using the full set of cross-block check blocks generated for a given RV index (i.e., using the set of interleavers associated with the RV index), as well as examples in which a retransmission by a CUE is performed using only a subset (i.e., fewer than all) of the cross-block check blocks associated with a given RV index.

The present disclosure has also described how UE cooperation may be configured at the UEs, using centralized cooperation or using distributed cooperation, and examples of signaling for each type of cooperation.

Examples of the present disclosure may be useful in non-terrestrial networks (e.g., satellite communications). Conventional HARQ retransmission schemes may be inefficient for non-terrestrial (e.g., satellite) communications due to the long round-trip delay in satellite communications. Using examples of the present disclosure, UEs that successfully decoded an initial transmission may serve as CUEs to perform retransmissions to other UEs, without requiring a non-terrestrial transmitter node to perform retransmissions. UE cooperation as disclosed herein (in particular centralized cooperation using a terrestrial centralized entity, or distributed cooperation) may enable a practical retransmission scheme that does not require feedback to be sent from UEs to a non-terrestrial transmitter node (e.g., a satellite).

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at a first receiver node, the method comprising:
receiving an initial transmission from a first transmitter node, the initial transmission comprising a plurality of code blocks;
performing a decoding operation to decode the plurality of code blocks;
generating one or more cross-block check blocks using bits selected from across the plurality of code blocks; and
transmitting, in a retransmission, at least one cross-block check block of the one or more cross-block check blocks to a second receiver node, the first receiver node and the second receiver node both being intended recipients of the initial transmission.

2. The method of claim 1, further comprising:
prior to the generating and the transmitting, receiving, from the first transmitter node or a second transmitter node, configuration information of one or more parameters,
wherein the generating comprises:
generating the one or more cross-block check blocks in accordance with the one or more parameters.

3. The method of claim 2, further comprising:
prior to the receiving the configuration information, transmitting an acknowledgement (ACK) to the first transmitter node or the second transmitter node indicating decoding was successful,
wherein the configuration information is received in response to the ACK.

4. The method of claim 2, wherein the first receiver node is configured with an index indicating an order among a group of receiver nodes, and wherein the at least one cross-block check block is transmitted to the second receiver node in accordance with the order.

5. The method of claim 1, further comprising:
prior to the generating and the transmitting, receiving, from the second receiver node, a negative acknowledgement (NACK) indicating decoding was not successful at the second receiver node,
wherein the generating and the transmitting are performed in response to the receiving the NACK from the second receiver node.

6. The method of claim 5, wherein the first receiver node is configured with an index indicating an order of the first receiver node among a group of receiver nodes that are intended recipients of the initial transmission, and wherein the at least one cross-block check block is transmitted to the second receiver node in accordance with the order.

7. A method at a first receiver node, the method comprising:
receiving an initial transmission from a first transmitter node, the initial transmission comprising a plurality of code blocks;
performing a decoding operation to decode the plurality of code blocks, decoding being unsuccessful;
receiving, in a retransmission, at least one cross-block check block from a second receiver node, the first receiver node and the second receiver node both being intended recipients of the initial transmission; and
performing another decoding operation using the at least one cross-block check block to assist in decoding the plurality of code blocks.

8. The method of claim 7, further comprising:
receiving, in another retransmission, at least one different cross-block check block from a third receiver node, the first receiver node, the second receiver node, and the third receiver node all being intended recipients of the initial transmission,
wherein the another decoding operation is performed using all cross-block check blocks received from both the second receiver node and the third receiver node to assist in decoding the plurality of code blocks.

9. The method of claim 7, further comprising:
following the decoding being unsuccessful, transmitting, to the first transmitter node or a second transmitter node, a negative acknowledgement (NACK) indicating the decoding was unsuccessful,
wherein the retransmission is received following the transmitting the NACK.

10. The method of claim 7, further comprising:
following the decoding being unsuccessful, transmitting, to at least the second receiver node, an NACK indicating the decoding was unsuccessful,
wherein the retransmission is received following the transmitting the NACK.

11. An apparatus comprising:
a memory storing instructions; and
at least one processor caused, by executing the instructions, to cause the apparatus to perform operations including:
receiving an initial transmission from a first transmitter node, the initial transmission comprising a plurality of code blocks;
performing a decoding operation to decode the plurality of code blocks;
generating one or more cross-block check blocks using bits selected from across the plurality of code blocks; and
transmitting, in a retransmission, at least one cross-block check block of the one or more cross-block check blocks to a second receiver node, the apparatus and the second receiver node both being intended recipients of the initial transmission.

12. The apparatus of claim 11, the operations further including:
prior to the generating and the transmitting, receiving, from the first transmitter node or a second transmitter node, configuration information of one or more parameters,
wherein the generating comprises:
generating the one or more cross-block check blocks in accordance with the one or more parameters.

13. The apparatus of claim 12, the operations further including:
prior to the receiving the configuration information, transmitting an acknowledgement (ACK) to the first transmitter node or the second transmitter node indicating decoding was successful,
wherein the configuration information is received in response to the ACK.

14. The apparatus of claim 12, wherein the apparatus is configured with an index indicating an order among a group of receiver nodes, and wherein the at least one cross-block check block is transmitted to the second receiver node in accordance with the order.

15. The apparatus of claim 11, the operations further including:
prior to the generating and the transmitting, receiving, from the second receiver node, a negative acknowledgement (NACK) indicating decoding was not successful at the second receiver node,
wherein the generating and the transmitting are performed in response to the receiving the NACK from the second receiver node.

16. The apparatus of claim 15, wherein the apparatus is configured with an index indicating an order of the apparatus among a group of receiver nodes that are intended recipients of the initial transmission, and wherein the at least one cross-block check block is transmitted to the second receiver node in accordance with the order.

17. An apparatus comprising:
a memory storing instructions; and
at least one processor caused, by executing the instructions, to cause the apparatus to perform operations including:
receiving an initial transmission from a first transmitter node, the initial transmission comprising a plurality of code blocks;
performing a decoding operation to decode the plurality of code blocks, decoding being unsuccessful;
receiving, in a retransmission, at least one cross-block check block from a second receiver node, the apparatus and the second receiver node both being intended recipients of the initial transmission; and
performing another decoding operation using the at least one cross-block check block to assist in decoding the plurality of code blocks.

18. The apparatus of claim 17, the operations further including:
receiving, in another retransmission, at least one different cross-block check block from a third receiver node, the apparatus, the second receiver node, and third receiver node all being intended recipients of the initial transmission,
wherein the another decoding operation is performed using all cross-block check blocks received from both the second receiver node and the third receiver node to assist in decoding the plurality of code blocks.

19. The apparatus of claim 17, the operations further including:
following the decoding being unsuccessful, transmitting, to the first transmitter node or a second transmitter node, a negative acknowledgement (NACK) indicating the decoding was unsuccessful,
wherein the retransmission is received following the transmitting the NACK.

20. The apparatus of claim 17, the operations further including:
following the decoding being unsuccessful, transmitting, to at least the second receiver node, an NACK indicating the decoding was unsuccessful,
wherein the retransmission is received following the transmitting the NACK.
